(19) United States
(12) Patent Application Publication
(10) Pub. No.: US 2019/0057454 A1
(43) Pub. Date: Feb. 21, 2019

(54) IMMUTABLE ELECTRONIC PLATFORM FOR INSURANCE SELECTION

(71) Applicant: United Parcel Service of America, Inc., Atlanta, GA (US)

(72) Inventors: ARKADIUSZ KOMENDA, Mahway, NJ (US); COREY WRIGHT, DuPont, WA (US)

(21) Appl. No.: 16/105,461

(22) Filed: Aug. 20, 2018

Related U.S. Application Data
(60) Provisional application No. 62/547,466, filed on Aug. 18, 2017.

(51) Int. Cl. G06Q 40/08; G06Q 10/08; H04L 9/32

(52) U.S. Cl. CPC G06Q 40/08; G06Q 10/083; H04L 2209/56; H04L 9/3242; H04L 2209/38; H04L 9/3247

(57) ABSTRACT

Embodiments are provided for automating selection of insurance policies for physical assets via a distributed ledger. A computing device, which in some instances can be coupled to or associated with a physical asset, can determine that a distributed ledger maintained by a plurality of distributed nodes includes a first transaction that corresponds to a request for insurance associated with the physical asset being transported from a first location to a second location. The computing device can also determine that the distributed ledger includes a set of second transactions that correspond to a set of insurance policies that each reference the first transaction, each transaction in the corresponding set of second transactions having insurance policy parameters that are determined based on the insurance request criteria. A transaction is generated for communication to a node for storage into the distributed ledger, where the generated transaction references an optimal insurance policy selected from the set of insurance policies based on predetermined weights.

### CROSS-REFERENCE TO RELATED APPLICATIONS

This application having attorney docket number UPSE.277639 and entitled “Immutable Electronic Platform for Insurance Selection”, claims priority to U.S. Application No. 62/547,466, filed Aug. 18, 2017, entitled “Immutable Electronic Platform for Insurance Selection,” the entirety of which is incorporated by reference herein.

### TECHNICAL FIELD

The field relates to an immutable electronic transaction platform for autonomously selecting and securing insurance.

### BACKGROUND

Insurance coverage is often sought for the delivery of physical assets in a logistics network. In certain circumstances, a shipper may seek insurance coverage for a physical asset being shipped. However, as discussed in greater detail below, traditional technologies have a number of problems. For instance, the time window to acquire shipping insurance is generally limited, as an entity seeking to insure a physical asset must do so prior the physical asset entering a logistics network. Further, traditional technologies have not allowed for automatic selection of shipping insurance based on customizable criteria and needs-based analytics.

### SUMMARY

This summary is provided to introduce a selection of concepts in a simplified form that are further described below in the detailed description section of this disclosure. This summary is not intended to be used to identify key or essential features of the claimed subject matter, and it is not intended to be used as an aid in determining the scope of the claimed subject matter.

In brief, and at a high level, this disclosure describes, among other things, systems and methods for providing an immutable electronic transaction platform for securing shipping insurance and then using that platform to autonomously manage insurance coverage. In exemplary embodiments, a computer-implemented method for automating selection of insurance policies for physical assets is provided. The method comprises determining, by a computing device, that a distributed ledger maintained by a plurality of distributed nodes includes a first transaction that corresponds to a request for insurance associated with a physical asset being transported from a first location to a second location, the request comprising insurance request criteria for the insurance request. The method further comprises determining, by the computing device, that the distributed ledger includes a set of second transactions that corresponds to a set of insurance policies that each reference the first transaction, each transaction in the corresponding set of second transactions having insurance policy parameters that are determined based on the insurance request criteria. Additionally, the method comprises generating, by the computing device, a transaction that is communicated to at least one node of the plurality of distributed nodes for storage into the distributed ledger, the generated transaction referencing an optimal insurance policy selected from the set of insurance policies based on predetermined weights.

In another embodiment, a system is provided for automating selection of insurance policies for physical assets, the system comprising one or more processors and computer storage memory having computer-executable instructions stored thereon which, when executed by the processor, implement a method of generating an insurance transaction that comprises determining, by a computing device, that a distributed ledger maintained by a plurality of distributed nodes includes a first transaction that corresponds to a request for insurance associated with a physical asset being transported from a first location to a second location, the request comprising insurance request criteria for the insurance request. The method also comprising determining, by the computing device, that the distributed ledger includes a set of second transactions that corresponds to a set of insurance policies that each reference the first transaction, each transaction in the corresponding set of second transactions having insurance policy parameters that are determined based on the insurance request criteria. Additionally, the method comprises generating, by the computing device, a transaction that is communicated to at least one node of the plurality of distributed nodes for storage into the distributed ledger, the generated transaction referencing an optimal insurance policy selected from the set of insurance policies based on predetermined weights.

It a further embodiment, a method is provided for automating selection of insurance policies for physical assets. The method comprises obtaining, by a computing device associated with a parcel, predefined criteria for a physical asset contained within the parcel, wherein the computing device is coupled to at least a first sensor operable to detect a state of the parcel. The method further comprises determining, by the computing device, that a present or future environmental condition of the parcel exceeds a threshold included in the obtained predefined criteria based on sensor data received from the first sensor. Additionally, the method comprises generating, by the computing device, a first transaction that includes an insurance request having insurance criteria and an indication of pre-authorization based on the obtained predefined criteria, wherein the generated first transaction is digitally-signed with a unique key associated with the parcel and is generated for communication to a node of a plurality of distributed nodes that collectively maintain a distributed ledger. The method also comprises determining, by the computing device, that the maintained distributed ledger includes a set of second transactions that each corresponds to one of a set of proposed insurance policies, each transaction in the set of transactions referencing the digitally-signed first transaction. The method further comprises communicating, by the computing device, a generated third transaction that corresponds to an optimal insurance policy that is selected from the identified set of proposed insurance policies based on the predefined criteria, wherein the generated third transaction is digitally-signed with the unique key.

### BRIEF DESCRIPTION OF THE DRAWINGS

The present invention is described in detail below with reference to the attached drawing figures, wherein:

FIG. 1 is an exemplary system diagram of a distributed ledger network in accordance with some embodiments of the present disclosure;

FIG. 2 is an exemplary system diagram of an insurance selection platform in accordance with some embodiments of the present disclosure;

FIG. 3 is an exemplary system diagram of an insurance selection platform in accordance with some embodiments of the present disclosure;

FIG. 4 is an exemplary system diagram of an insurance claim resolution platform in accordance with some embodiments of the present disclosure;

FIG. 5 depicts an exemplary flow diagram of a method for generating a transaction in accordance with some embodiments of the present disclosure;

FIG. 6 depicts an exemplary flow diagram of a method for generating a transaction in accordance with some embodiments of the present disclosure;

FIG. 7 depicts an exemplary flow diagram of a method for resolving a claim request in accordance with some embodiments of the present disclosure; and

FIG. 8 is a diagram of a system that can be used to practice various embodiments of the present disclosure.

### DETAILED DESCRIPTION

The subject matter of the present disclosure is described with specificity herein to meet statutory requirements. However, the description itself is not intended to limit the scope of the technology. Rather, the claimed subject matter might be embodied in other ways, to include different steps, or combinations of steps, similar to the ones described in this disclosure, and in conjunction with other present or future technologies. Moreover, although the terms “step” or “block” may be used herein to describe different elements of methods employed, the terms should not be interpreted as implying any particular order among or between such steps or blocks unless the order of individual steps or blocks is explicitly described and required.

At a high level, this disclosure relates to methods and systems for establishing an immutable electronic transaction platform for securing insurance. For ease of understanding, the platform in described in the context of securing insurance for an item being shipped, but it should be understood that the platform could be used to secure any type of insurance. For example, embodiments can provide an autonomous smart insurance selection platform (“ASI-SP”) and automatic claim resolution system (“AIC-RS”).

A number of limitations exist with conventional technologies relating to the acquisition of parcel insurance. For instance, the time window to acquire shipping insurance is generally limited, as an entity seeking to insure a physical asset must do so prior the physical asset entering a logistics network. This limitation does not account for a change in conditions that may occur during the transportation of the physical asset, such as hazardous weather conditions, anticipated route changes or shipment delays, traffic congestion, or failures in cooling or heating equipment, among other things. In this regard, traditional technologies fail to enable the automatic selection of shipping insurance based on needs-based analytics or other customizable criteria. Current embodiments address these deficiencies by employing unique systems and methods that offer dynamic bidding and securement of insurance transactions for all parties involved in an insurance transaction. Exemplary embodiments provide a technological solution for a dynamic selection of insurance coverage, with some embodiments having the selection based on real-time updates during the transportation of the physical asset. In addition, some embodiments provide a technological solution that can assess, in real-time, current or anticipated environmental conditions that may have an effect on an already-shipped parcel based on sensors associated with the parcel.

As noted, conventional technologies fail to provide a technological solution that facilitates the securement of insurance. Additionally, conventional technologies fail to facilitate the securement of for an already-shipped physical asset. Typically, prior to shipping a physical asset, a consumer must invest time and effort to manually research third-party insurers by visiting a website associated with a third-party insurer. The consumer then submits a request for a quote, and waits for a response. The consumer must also “shop around” for various bids to select an insurance policy that they determine as being optimal to their shipment needs. Because technology has largely been unable to offer an enhanced technological solution to this conventional practice, the consumer undergoes a time-consuming process of independently contacting each insurer and waiting for the third-party insurer's response. Among other improvements, the embodiments described herein harnesses the power of distributed ledger technologies to offer a services that enable the consumer to preauthorize a package for autonomous needs-based insurance selection and securement of an optimal insurance policy based on a defined set of criteria. Similarly, the service can enable insurers to bid on insurance coverage for the parcel based on an indication that a parcel or computing device associated therewith has determined a need to secure insurance coverage. Various embodiments described herein generally relate to an autonomous smart insurance selection platform (ASI-SP) and automatic insurance claim resolution system (AIC-RS), each being described in the present disclosure.

The various components described herein are provided in relation to an autonomous smart insurance selection platform (ASI-SP) and automatic insurance claim resolution system (AIC-RS). The described components are provided to describe some embodiments in accordance with the present disclosure. It is contemplated that any components, sub-components, modules, or sub-modules described herein can be combined, interchanged, distributed, or re-arranged to accomplish the features and operations described in accordance with the present disclosure. The following descriptions each relate to various implementations or arrangements of the ASI-SP and the AIC-RS.

### Distributed Ledger Technologies

In various embodiments, information discussed herein may be stored in one or more distributed ledgers (e.g., a Blockchain). In certain embodiments, a distributed ledger system may store information/data indicative of various transactions associated with the transportation of the parcel and/or insuring the parcel. Each block may comprise information/data linking to a previous generated block, thereby providing a complete chain between the generation of information/data stored in the distributed ledger and the later use of the same information/data. For example, the distributed ledger may be used to establish a complete chain-of-possession of information/data, to establish when the parcel was damage and environmental conditions throughout the chain-of-possession, to establish whether the parcel was insured, and the like. The information/data stored in the various transactions/blocks may be encrypted/hashed or otherwise protected from unauthorized access (e.g., read access, write access, and/or delete access). In a non-limiting example, information stored in the various blocks may be irreversibly hashed, such that the hashed information/data may be used to verify the authenticity of transactions, but the hashed data may not be reverse-engineered to ascertain substantive information based on the hashed information alone. Moreover, information/data transmitted between various computing devices may be encrypted (e.g., using public/private key pairs to digitally sign and/or verify data) such that blocks/transactions stored within the block chain may be verified by multiple computing nodes having access to the public and/or private keys. Upon verification of the information/data to be stored in the Blockchain, the information/data may be hashed and stored as noted herein. The distributed ledger may be similar to the distributed ledger system described in U.S. patent application Ser. No. 16/027,523, filed on Jul. 5, 2018 titled “Verifiable Parcel Distributed Ledger Shipping and Tracking System,” which is incorporated in by reference.

The distributed ledger system may comprise one or more, Bitcoin-based blockchains, Ethereum-based blockchains, Hyperledger blockchains, Quroum, Corda, Hedera Hashgraph, and/or the like. The distributed ledger system may incorporate a single distributed ledger/Blockchain configured for storing all transactions therein, or the distributed ledger system may comprise a plurality of distributed ledgers/Blockchains, wherein each distributed ledger/Blockchain is utilized to store information/data indicative of a particular type of transaction. For example, a first Blockchain may be configured to store the consumer's insurance request having an insurance request criteria, and a second Blockchain may be configured to store one or more insurance policies having insurance policy parameters. As a further example, a first distributed ledger/Blockchain may be configured to store parcel shipping/tracking information/data, and a second distributed ledger/Blockchain may be configured to store value transfer information/data (e.g., via a virtual currency) related to an insurance claim that has been resolved by the AIC-RS. Accordingly, various embodiments may comprise and/or utilize digital currency/assets represented by ledger entries. Such digital currency/assets (e.g., Bitcoin, Ether, and/or the like) may itself have value that may be exchanged for various items, services, and/or the like. Such digital currency/assets thus may be utilized as a currency in various transactions. Moreover, various embodiments may utilize and/or comprise various digital assets and/or coins that may be exchanged for items and/or information/data having a defined value.

The distributed ledger may be stored in and/or by one or more computing nodes (e.g., node 110) of the distributed ledger system in complete or partial form. For example, it may be stored on a stationary computing device, a mobile computing device and/or an IoT enabled device (e.g., a package and/or container in the supply chain). It is contemplated that any computing device can operate as a node if it maintains a copy of the distributed ledger and is in communication with at least one peer node of the distributed ledger system. For example, each node may store a complete copy of the one or more distributed ledgers/Blockchains, and may be utilized for backup protection, validation of transactions/blocks, execution of smart contracts, and/or transaction verification purposes, among other things. The distributed ledger system may be publicly accessible, and may be distributed among a plurality of commercial computing devices (e.g., servers), user computing devices (e.g., desktop computers, laptop computers, and/or the like), and/or the like. However, in certain embodiments, the distributed ledger system may be privately accessible (e.g., permissioned), and may be stored by one or more computing nodes controlled by a single entity (e.g., the ASI-RS and/or the AIC-RS) or a consortium of trusted entities (e.g., participating courier service providers in a courier service provider network). In the latter embodiments, access to information/data stored in the distributed ledger may be limited to users having defined credentials (e.g., a private key, a passcode, and/or the like). In certain embodiments, information/data stored in the distributed ledger system may be hashed, encrypted, or otherwise protected from unauthorized access (e.g., read access and/or write access). The substantive information/data stored in the distributed ledger system may be accessible utilizing a private key to decrypt the stored information/data, or the substantive information/data may be inaccessible based on information/data stored in the distributed ledger. For example, the one or more transactions (such as a transaction capturing sensitive data regarding the contents of the parcel) may be stored in one or more privately distributed ledgers, which is only accessible to the ASI-SP, while other transactions (such as an insurance policy transaction and/or the insurance request transaction) is stored in a public Blockchain repository. Any and all aspects, and any variations thereof, are contemplated as being within the scope herein.

In various embodiments, each transaction/block in the distributed ledger may comprise asset-identifying information (e.g., parcel ID, parcel information/data, information/data of transacting entities), and may comprise data regarding environmental conditions of the physical asset and/or a shipping/tracking event for the physical asset. For instance, the shipping/tracking event may be a physical condition captured by the one or more sensors associated with the physical asset (e.g., a sensor physical coupled to the parcel itself and/or a sensor that is within the vicinity of the parcel, such as a sensor associated with the transportation vehicle). The physical event/condition may relate to environmental conditions (temperature, pressure, humidity, and the like) within the parcel itself and/or an environment outside of the parcel, such as a transportation vehicle and/or a storage facility. Additionally, the physical event/condition may relate to incidentals that may affect and/or damage the physical asset (or any contents thereof). In one aspect, the physical event/condition may be an accelerated movement of the physical asset that is detected by one or more sensors. For example, the accelerated movement could be a result of a sudden impact that may occur when the physical asset is mishandled (e.g., dropped) or inappropriately stored such that surrounding objects fall onto the physical asset or when the physical asset falls off a storage rack. Any and all combinations are within the scope of this disclosure.

In certain embodiments, each transaction/block may comprise at least a portion of the parcel information/data of a prior transaction/block, thereby providing a link back to the prior transaction/block representing a transaction involving the same and/or different parcel information/data. In one aspect, each new transaction/block may comprise parcel information/data, where the new transaction/block is linked to a prior transaction block based on hashing the combination of information/data associated with new transaction/block and the information associated with the one or more prior transactions/blocks. Similarly, the prior transaction/block may comprise a link to an even earlier transaction/block(s), and the chain of transactions/blocks can lead back to the originating or genesis transaction relating to the parcel.

In exemplary embodiments, the information/data can be uploaded to a Blockchain repository and linked. For example, the parcel information/data can be stored as a particular “block” (e.g., a parcel information block) that is linked to an insurance transaction block. Additionally or alternatively, the parcel information/data may be stored as a series of parcel information blocks, where each of the parcel information blocks are linked to the previously generated parcel information block. For example, each parcel information block may include cryptographic hash of a parcel information that is based on information associated with the previous block. In one embodiment, a first parcel information block may comprise a cryptographic hash associated with the information related to the insurance transaction block (e.g., a timestamp and/or data associated with the insurance transaction, such as the terms of the optimal insurance policy), as discussed above. The parcel information block may thus further secure the insurance transaction block as they are now linked.

In some aspects, the first parcel information block may also be associated with its own timestamp and/or the particular information (e.g., parcel information communicated by the smart parcel at a certain location) that can be relied upon by subsequent parcel information blocks. For instance, a second parcel information block may be created that is based on a cryptographic hash associated with information of the first parcel information block (e.g., the timestamp and/or parcel information associated with the first parcel information block). In this way, a series of parcel information blocks may be linked to the insurance transaction block. As described, building/linking the series of parcel information blocks from the electronic transaction block further secures the electronic transaction block since the electronic transaction block cannot be manipulated without destroying the entire Blockchain.

A new transaction block may be added that memorialize the events occurring to the physical asset (e.g., a pick-up, hand-off, and/or shipping/tracking event associated with the physical asset). The new transaction block may be added based on hashing, via a hashing algorithm, the information from one or more transactions/blocks and/or the newly added block. The hashing algorithm may be any suitable hashing algorithm that takes an input of any length and generates an output of a fixed length. For instance, the hashing algorithm may be a Pay-to-Script Hash (P2SH) algorithm, a Scrypt algorithm, a RIPEMD algorithm, a Secure Hash Algorithm (SHA), and/or the like. In embodiments, the hashing algorithm may be a SHA-256 algorithm. In certain embodiments, the hashing algorithm may be an MD5 algorithm. This may provide an immutable link between each transaction/block.

In various embodiments, a new transaction/block in a distributed ledger may be linked to a transaction/block of one or more secondary distributed ledgers. The secondary distributed ledger may be one or more side chains and/or one or more distributed ledgers. The secondary distributed ledger may be a public, private, and/or consortium distributed ledger as described in more detail below. In addition, the one or more side chains can memorialize or capture other information/transactions that is not captured by a primary distributed ledger. As such, the one or more side chains may run in parallel to other distributed ledgers but still be linked to transaction/blocks in a primary distributed ledger. In this way, each side chain may be a distributed ledger dedicated to capturing information that is not otherwise captured by the primary distributed ledges. By way of example only, the one or more secondary chains may capture information and/or transactions associated with services relevant to the physical asset (e.g., insurance coverage) and/or information relevant to the physical asset (e.g., information associated with delivery vehicle, environmental conditions, pick-up drop-off location, and route information).

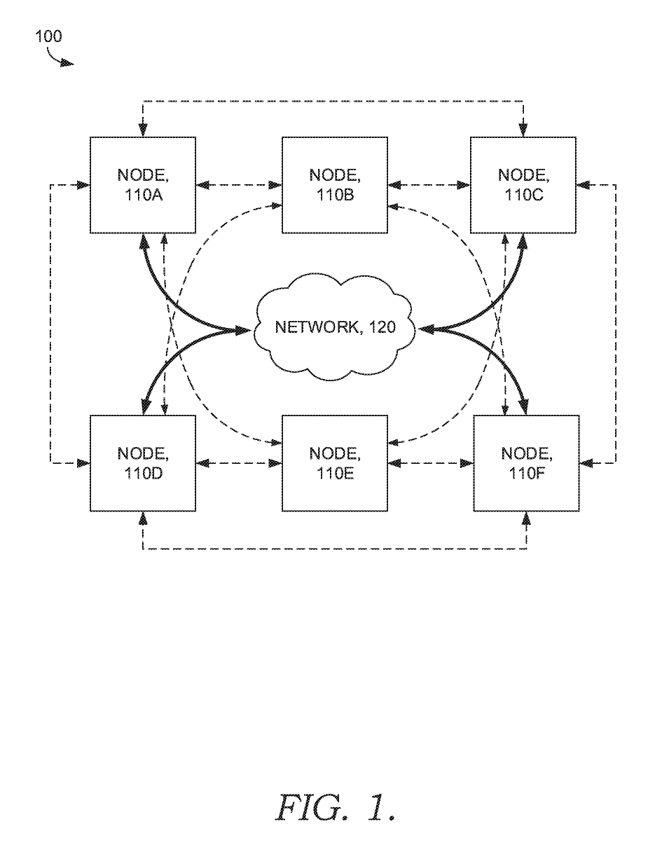

Turning now to FIG. 1, a schematic depiction is provided illustrating an exemplary distributed ledger network 100 in which some embodiments may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

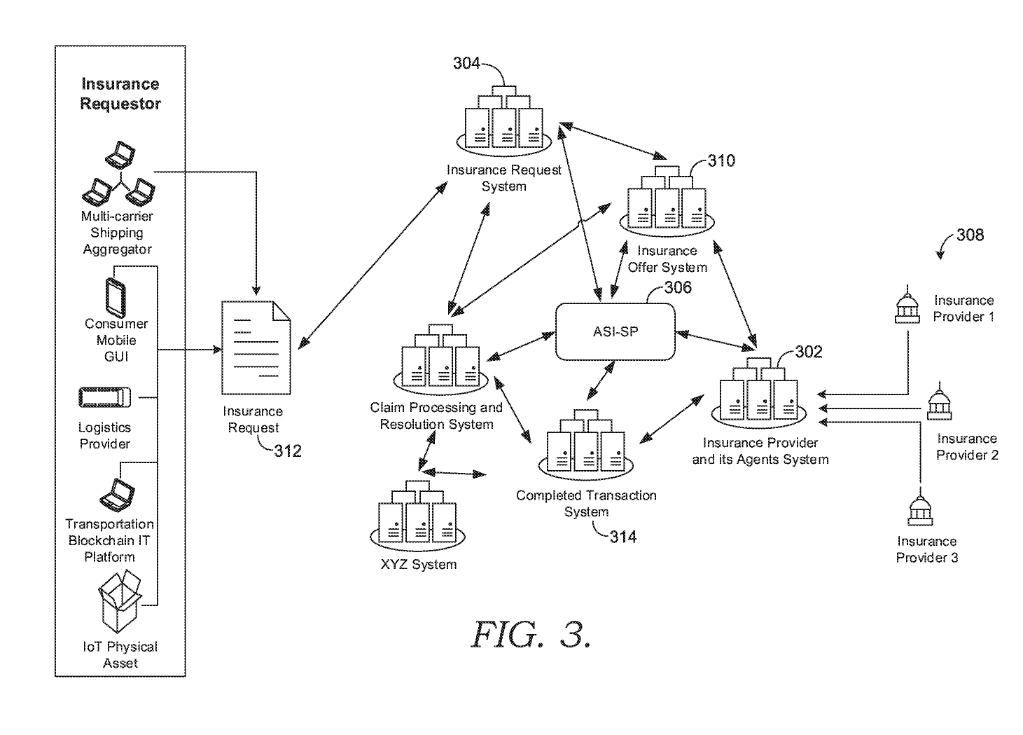

The distributed ledger network 100 depicted in FIG. 1 includes a plurality of nodes 110A-110F that are each in communication with one or more nodes 110A-110F over a network, such as the Internet. In accordance with the present disclosure, each node 110A-110F is a node of a distributed ledger network, as later described in accordance with FIG. 3, which is also a computing device later described in accordance with FIG. 800. In some embodiments, and preferably for public Blockchain implementations, each node 110A-110F in the distributed ledger network 100 can operate as a peer to every other node 110A-110F of the distributed ledger network 110 such that no single node 110A-110F is more influential or powerful than any other node 110A-110F. Operations performed by nodes can include, among other things, validating transactions, verifying blocks of transactions, and adding records to an immutable database that is collectively maintained by the nodes 110A-110F. It is contemplated, however, that in some embodiments, a particular subset of the nodes 110A-110F can be specifically designated for performing a subset of or all node operations described herein. In this regard, as opposed to embodiments where each node is a peer with other nodes, some embodiments can employ specially-“designated nodes” (preferably for private Blockchains or ecosystems where centralization is not a concern) that perform a subset of or all of the described node operations.

In accordance with embodiments described herein, the immutable database collectively maintained by the nodes 110A-110F is referenced herein as a Blockchain. The Blockchain maintained by the distributed ledger network 100 includes a plurality of records that is immutable by virtue of the distributed nature of the distributed ledger network 100, applied cryptography concepts, and a consensus module (not shown) that is independently included and operated by any number of nodes 110A-110F. While any node can generate a transaction to be added to the Blockchain, the consensus module requires that the record be added to the Blockchain only based on a determination that a consensus (e.g., greater than 50%) of the nodes 110A-110F (or designated nodes) has collectively validated the transaction. In this regard, while each node 110A-110F can independently store a copy of the Blockchain, a record can only be added to the Blockchain when a consensus to add the record has been reached by the nodes 110A-110F (or designated nodes) of the distributed ledger network 100.

In various embodiments, validation of a transaction is facilitated utilizing features of asymmetric key cryptography (i.e., public-private key pairs), among other things. In some aspects, as is commonly known in public Blockchains (e.g., Bitcoin), a private key can be employed to generate one or more associated public keys, encrypt data that can only be decrypted by an associated public key, and/or digitally sign data or transactions. On the other hand, a public key can be employed to decrypt data encrypted by an associated private key, encrypt data that only the private key can decrypt, and/or digitally authenticate a digital signature generated by an associated private key. As public keys can be shared freely, public keys generally function as “wallet addresses” that are associated with a private key. In this regard, digital tokens or other units of value (e.g., Bitcoin) can be “transmitted” from one wallet address (i.e., a public key of a sender) to another wallet address (i.e., a public key of a receiver). In actuality, however, the transmission of a digital token or unit of value is not a physical transfer, but is represented as a record of transfer from one wallet address to another that, if validated, is recorded onto the Blockchain. The record is not finalized (i.e., added to the Blockchain), however, until the transfer is validated by a consensus of the nodes 110A-110F in the distributed ledger network 100.

To generate a transaction block or to transfer a digital token(s), the owner of the sending wallet address must digitally sign the transaction with the private key associated with the sending wallet address. Nodes 110A-110F (or designated nodes) of the distributed ledger network 100 must independently determine that the transaction from the sending wallet address is valid by digitally authenticating the digital signature with the sending wallet address (i.e., the public key). If a token is being transferred, the nodes 110A-110F (or designated nodes) must also independently determine, by referencing their independently-stored copy of the Blockchain, that the sending wallet address is in fact associated with the digital token being transferred, or that the sending wallet address has sufficient liquidity (i.e., has a calculated aggregate value based on associated records in a local copy of the Blockchain) to transfer the unit(s) of value. If a node (or designated node) in the distributed ledger network 100 determines that the foregoing condition(s) is not satisfied, the transaction is determined invalid by the node and the transaction is not passed on (e.g., communicated) to other nodes (or designated nodes) to which it is connected. On the other hand, if the node (or designated node) determines that the foregoing condition is satisfied, the transaction is determined valid and the node passes on (e.g., communicates) the transaction, along with an indication that the node independently validated the transaction, to other nodes 110A-110F (or designated nodes) to which it is connected. As the nodes 110A-110F in the distributed ledger network 100 are all directly or indirectly connected to one another, this validation process continues until the nodes (or designated nodes) collectively determine that a majority (i.e., consensus) has validated the transaction. The collective determination of consensus can be facilitated by virtue of each node (or designated node) maintaining a list of other nodes (or designated nodes) on the network (e.g., by I.P. address or other identifier) along with their respective determinations of transaction validity.

After a consensus of validity for a transaction has been reached by the nodes 110A-110F (or designated nodes), the transaction awaits confirmation (i.e., addition to the Blockchain). As the nodes 110A-110F (or designated nodes) can be peers with each other, any node (or designated node) can participate in the process of adding the transaction to the Blockchain. For purposes of background, the Blockchain includes records of validated transactions that are grouped into a cryptographically chained series of blocks, whereby each block includes a subset of these records. Any node 110A-110F (or designated node) can perform the process of block generation, which can be implemented in a variety of ways based on a consensus algorithm implemented within its consensus module including, but not limited to, proof of work, proof of stake, proof of authority, practical Byzantine Fault Tolerance, or Federated Byzantine Agreements. As the aforedescribed processes for block generation are generally known in the art, additional detail for these processes are not described herein. It is contemplated, however, that any implementation of block generation and consensus determination can be employed in accordance with the present disclosure. More importantly, as the general outcome of block generation is relatively similar among these implementations, the following description is provided irrespective of the block generation aspect of the consensus module.

To add a validated transaction to the Blockchain, the transaction must first be included into a block that is being generated by one of the nodes 110A-110F (or designated nodes) and subsequently validated by a consensus of the nodes (or designated nodes) in the distributed ledger network 100. The transaction can be independently included into a block, or grouped together with other transactions, either of which are included within the purview of the present disclosure. Such implementations may vary, however, based on consensus module design and/or a block size (i.e., memory limitation) implemented or defined within in the consensus module operated by the nodes 110A-110F (or designated nodes). The node generating the block must also include, into the block it is generating, a cryptographic hash of the block most-recently added to the Blockchain. Once generated in accordance with consensus rules defined within the consensus module, the node generating the block can send the generated block to the nodes (or designated nodes) to which it is connected.

The nodes (or designated nodes) receiving the generated block can then verify that the block includes one or more valid transactions, includes a hash value of the block most-recently added to the Blockchain, and was generated in accordance with the defined consensus rules. Upon verifying the foregoing, the nodes (or designated nodes) can pass on (e.g., communicate) the verified block to its neighboring nodes (or neighboring designated nodes). In this way, similar to how a transaction is validated by a determined consensus of the distributed ledger network 100, the generated block including at least the transaction can be verified by another determined consensus of the nodes (or designated nodes). When a determination is made by a consensus of the nodes 110A-110F (or designated nodes) that a block is verified, the newly-verified block is added to the Blockchain immediately subsequent to the previously-added block, the hash of the previously-added block being included in the newly-verified block. As such, each block is cryptographically “chained” to a previous block and a subsequent block. In other words, the cryptographic hashes facilitate maintenance of the order and accuracy of records included in the Blockchain.

In some instances, if the same transaction is included into a block generated by different nodes (or designated nodes) and validated throughout the network within a substantially similar timeframe, the blocks can be temporarily confirmed leading up to a fork in the Blockchain (e.g., two potential branches stemming from the main chain). The forked chain can be maintained by the nodes (or designated nodes) until a determination is made, by a consensus of the distributed ledger network 100, that one of the forks has a larger quantity of blocks than the other. Based on a subsequent determination that one of the forks is shorter than the other, the nodes (or designated nodes) can prune (e.g., delete) the shorter chain, and maintain the longer chain as the determinative Blockchain.

In various embodiments, the Blockchain is not necessarily limited to storing records relating to transfers of digital tokens or monetary value. In this regard, a record can include any type of electronic record, including but not limited to one or more transactions, smart contracts, electronic documents, images or other digital media, URIs, alphanumeric text, unique identifiers, I.P. addresses, timestamps, hashes of any of the foregoing, or references to any of the foregoing. Any of the foregoing examples can be viewed as being the subject of a transaction, or can be indirectly associated with a transaction. For instance, ownership of an asset stored in a medium other than the Blockchain (e.g., a remote storage device, a cloud server, a database) can be referenced with a unique identifier. If the asset is a digital asset, a URI and/or hash of the digital asset can be the subject of the transaction. If the asset is a tangible asset, a unique identifier associated with the tangible asset can be the subject of the transaction. It is contemplated that any combination or alternative to the foregoing examples remain within the purview of the present disclosure.

With specific regard to smart contracts stored as records on the Blockchain, a smart contract can include any algorithm that defines an action or event that is to be triggered based on a determination that one or more defined conditions precedent to the action or event have occurred. In various embodiments, a smart contract can be generated, transmitted, received, stored, validated, and/or verified by any node or computing device described in accordance with the present disclosure. It is further contemplated that a consensus module of each node or computing device in the distributed ledger network 100 is capable of interpreting and executing a Turing complete programming language, such as Solidity, by way of non-limiting example. It is further contemplated that in some embodiments, the Blockchain itself is implemented based on the same programming language.

In various embodiments, smart contracts stored on the Blockchain can be associated with a corresponding address, similar to that of a wallet address. The smart contract can be assigned a corresponding address by the distributed ledger network 100, or can be associated with a wallet address associated with one or more private keys. Counterparties associated with a smart contract can verify, via their respective computing devices in communication with one or more nodes of the distributed ledger network 100, that the smart contract has been immutably stored onto the Blockchain based on a determined consensus of the nodes 110A-110F.

As smart contracts can be stored on the Blockchain, each node (or designated node) can independently determine whether a smart contract's defined conditions precedent have occurred in order to verify that the terms of the smart contract have been met. In various embodiments, each node (or designated node) can determined occurrence of defined conditions precedent based on electronic information communicated thereto or retrieved thereby. The electronic information can include, among other things, another transaction addressed to or referencing the smart contract, data from one or more computing devices remote from the distributed ledger network 100, data from a website, data from a database, published news events, published weather events, or any other type of electronic information that can be transmitted to or accessed by a node (or designated node) via the network 120.

Like other transactions, each node (or designated node) can communicate this verification to one or more neighboring nodes (e.g., other nodes in direct communication with the node or designated node) until a consensus of the nodes 110A-110F (or designated nodes) of the distributed ledger network 100 have collectively verified occurrence of the defined conditions precedent. Based on a determination that the defined conditions precedent has been verified by a consensus of the nodes 110A-110F, the event or action defined by the smart contract can be executed. In various embodiments, the event or action can include the processing of a transaction (e.g., a processing of a transfer for digital tokens or value) that is held or locked until a determination that the conditions precedent have occurred. In this regard, any digital asset that is subject to the smart contract can be locked (e.g., held in escrow) by the smart contract until the determination has been made.

### Operating Environment

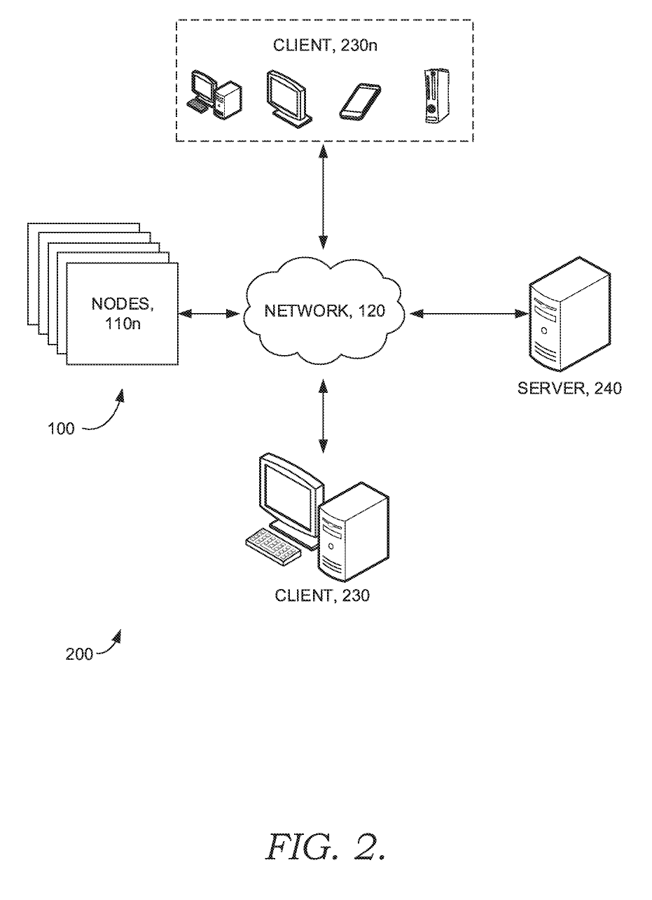

Referring now to FIG. 2, a schematic depiction is provided illustrating an exemplary system 200 in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

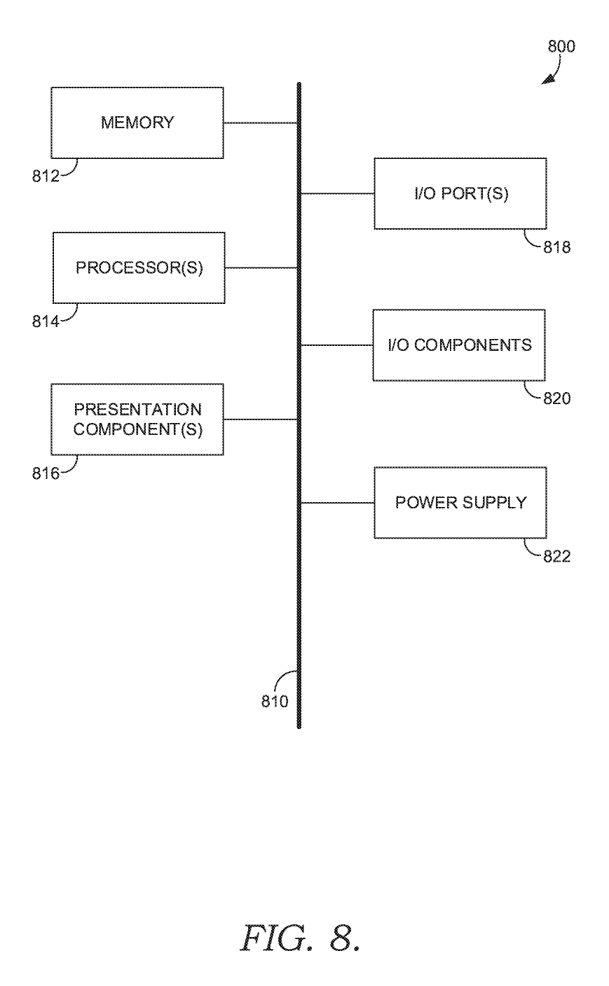

The system 200 can include, among other things, a distributed ledger network 100 comprising a plurality of nodes 110n as described with reference to FIG. 1, each in direct or indirect communication with one another via a network 120. It is contemplated that the nodes 110n can include a subset of designated nodes authorized to perform specifically-designated operations, such as validation, verification, or block generation, among other things. The system can also include one or more client devices, such as client 230, 230n. It is contemplated that any one or more nodes 110n can be a client 230, 230n, and one or more clients, 230, 230n can be a node in accordance with embodiments described herein. In this regard, nodes 110n and clients 230, 230n are computing devices also described herein in accordance with FIG. 8.

In one aspect, a client 230, 230n and can include the consensus module similarly included in other nodes 110n (or designated nodes) within the distributed ledger network 100. In another aspect, the client 230, 230n can generate transactions that can initially be validated locally, via the consensus module included therein, before the transaction is passed on to other nodes. In another aspect, a client 230, 230n can be in communication with one or more nodes 110n via the network 120, and can locally generate a transaction for communication via the network 120 to one or more nodes 110n that the client 230, 230n is in communication with. In this way, the one or more nodes 110n (or designated nodes) receiving the transaction directly or indirectly from the client 230, 230n can validate the transaction in accordance with the present disclosure.

In some aspects, any node 110n can operate as a node that includes the consensus module, and any client 230, 230n can operate as a client device that can: transmit communications to one or more nodes 110n, generate transactions, and receive communications (e.g., transaction status, Blockchain data) from one or more nodes 110n. For purposes of simplicity, the following description will reference a client 230, 230n as a node 110n, though embodiments are not limited as such.

In some embodiments, the system 200 can further include a server device, such as server 240. The server 240 can be in communication with one or more nodes 110n to send generated transactions to the one or more nodes 110n, request and receive transaction status information from the one or more nodes 110n, and/or request and receive Blockchain data from the one or more nodes 110n, among other things. In some further embodiments, server 240 can include can include one or more computing devices, also described in accordance with FIG. 800, whereby the one or more computing devices include a consensus module to operate as a node 110n (or designated node). Among other things, the server 240 can further provide one or more services, such as data storage services, web hosting services for one or more websites, user authentication services, certificate authentication services, backup services, data mining services, “cloud”-stored data or web search services, block explorer services, analytics services, and the like, including any combination thereof.

### Exemplary Physical Asset

As described, consumers often seek insurance coverage on the shipment of a parcel (also referred to herein as a physical asset). A parcel may be any tangible and/or physical object configured for containing, enclosing, or carrying an asset or an item. It should be understood that the term parcel as used herein is to be interpreted broadly to include any items being shipped, including those shipped as or in one or more packages, bags, containers, loads, crates, pallets, drums, trucks, trailers, cargo containers, and the like, and/or similar words used herein interchangeably. Such parcels may be picked up and/or delivered by a carrier/transporter, for example, via one or more carrier service levels, such as Same Day Air, Same Day Ground, Next Day Air, Next Day Ground, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like.

In some embodiments, the parcel may be a smart parcel. The smart parcel may be IoT enabled that allows it to interface with one or more wireless networks, as discussed below. The parcel may comprise one or more wireless network interface devices to provide a “smart” parcel, such as the shipments/items described in co-pending U.S. patent application Ser. No. 15/623,989, filed Jun. 15, 2017, the contents of which are incorporated herein by reference in their entirety. Additionally or alternatively, the parcel may comprise any computing component depicted in FIG. 8. As such, the parcel may communicate with one or more systems described herein. For example, the parcel may communicate with the ASI-SP to determine an optimal insurance policy. As a further example, the parcel may communicate with the AIC-RS to submit insurance claim information.

Such parcels may include components or modules, or may be coupled to a computing device having such components or modules, having the ability to communicate (e.g., via a chip (e.g., an integrated circuit chip), RFID, NFC, Bluetooth, Wi-Fi, and any other suitable communication techniques, standards, or protocols) with one another and/or communicate with various computing devices for a variety of purposes. For example, the parcel may be configured to communicate with one or more computing devices at one or more locations (e.g., a shipper location, a carrier location, and/or a recipient/consignee location) using a short/long range communication technology, as described in co-pending U.S. patent application Ser. No. 15/348,189, filed on Nov. 11, 2016 and the contents of which are incorporated herein by reference in its entirety. Further, such parcels may have the capabilities and components described with regard to the computing nodes 110, networks, vehicles, transaction computing devices, and/or the like. For example, the parcel may be configured to store item information/data. The item information may be used to generate a digital token that is associated with the parcel. In exemplary embodiments, the parcel information/data may comprise one or more of a consignee name/identifier, a shipment identifier, a service point (e.g., delivery location/address, pick-up location/address), instructions for delivering the parcel, a parcel delivery authorization code, information/data regarding if a parcel is present at the service point (e.g., a recipient location), and/or the like. In this regard, in some example embodiments, a parcel may communicate send “destination” address information/data, received “origin” address information/data, unique identifier codes, and/or various other information/data.

In some embodiments, each parcel may include a unique shipment identifier, such as an alphanumeric identifier. Such shipment identifiers may be represented as text, barcodes, tags, character strings, Aztec Codes, MaxiCodes, Data Matrices, Quick Response (QR) Codes, electronic representations, and/or the like. A unique shipment identifier (e.g., 123456789) may be used by the carrier to identify and track the parcel as it moves through the carrier's transportation network. Further, such parcel identifiers can be affixed to parcels by, for example, using a sticker (e.g., label) with the unique parcel identifier printed thereon (in human and/or machine readable form), the unique identifier printed on the parcel itself, an RFID tag with the unique parcel identifier stored therein, and/or other onboard computing devices operating as IoT enabled modules provided on the parcel. In some aspects, the parcel identifiers can be wireless emitted by the IoT enabled module, or in some instances, generated for display by the IoT enabled module for presentation on a display device in communicated therewith.

In various embodiments, packaging materials (e.g., boxes, envelopes, padded envelopes, sleeves, and/or the like) utilized for the parcel may incorporate the one or more electrical components, including a power supply, therein. The power supply may be embodied as a battery, such as a lithium battery, that may be incorporated into the packaging materials. In certain embodiments, the battery may be printed onto the packaging materials (e.g., as a portion of a printed label). In various embodiments, the one or more electrical components may be configured to automatically activate upon sealing the packaging materials. For example, the packaging materials may comprise one or more electronic contacts (e.g., conductors) embedded, printed, and/or the like in one or more portions of the packaging materials, such that the electronic contacts collectively form a complete, closed circuit with one or more onboard computing components (e.g., batteries, processors, memory storage areas, wireless receivers (e.g., RFID receivers, BLE receivers, Wi-Fi receivers, and/or the like), wireless transmitters (e.g., RFID transmitters (active or passive), BLE transmitters, Wi-Fi transmitters, and/or the like), and/or the like). In certain embodiments, the electronic contacts may comprise printed conductors (e.g., 3-D printed conductors, inkjet printed conductors, and/or the like), such as conductive inks, sintered conductive materials, semi-conductive materials, and/or the like. When the packaging materials are closed, in some embodiments, the electronic contacts enable current to flow between the onboard battery and the onboard computing components such that the onboard computing components are active (e.g., able to transmit and/or receive information/data).

Moreover, in certain embodiments, the parcel may comprise one or more sensors configured to detect a condition of the parcel and/or the environment of the parcel. For example, the parcel may comprise temperature sensors, humidity sensors, accelerometers (to detect impacts and/or drops), and/or the like. As discussed herein, the one or more sensors within the parcel may be utilized to determine whether the parcel conditions remained consistent with expected shipping conditions, thereby enabling the use of condition-based smart contracts as discussed herein.

For instance, the parcel may comprise a sensor that detects the state of the parcel. The state of the parcel generally refers to the condition of the parcel at a particular moment in time. As such, the state of the parcel may relate to a geolocation, environmental conditions, an entity or vehicle having current physical possession of the parcel, and the like. In one aspect, the sensor is a location-based sensor that detects a location of the parcel (e.g., a set of GPS coordinates, a set of wireless signal identifiers, or a set of radio tower identifiers). In some embodiments, the parcel is IoT enabled and can utilize the sensor data to determine a present or future environmental condition of the parcel. In exemplary, embodiments, the parcel is IoT enabled and communicates to a computing device communicatively coupled to the parcel and can utilize the sensor data to determine a present or future condition of the parcel. For example, if the location of the parcel corresponds to an unexpected shipping route, a computing device can forecast a new delivery route and determine potential future conditions associated with the new delivery route. In some embodiments, the computing device further relies on data collected from one or more external databases (social media websites, news outlets, weather forecasts, logistic network data, and the like) that are relevant to the new, forecasted delivery route.

In various embodiments, the IoT enabled parcel autonomously requests insurance coverage. This may be done by the decision support logic executed by a computing device associated with the parcel. The insurance decision logic may be rules that are relied upon by the smart parcel to determine when, if at all, to obtain insurance coverage. The insurance decision logic may comprise any rule, logic, condition, prediction, pattern inference algorithm, machine learned model, and the like, that is capable of determining whether or not to obtain insurance coverage. In some aspects, the insurance decision logic may be obtained from the ASI-SP 306. In aspects, the insurance decision logic utilizes the data collected by one or more sensors associated with parcel to determine if an insurance request 312 should be submitted. If the insurance decision logic indicates that insurance coverage should be obtained, a computing device associated with the IoT enabled parcel can submit a request for insurance. As such, the IoT enabled parcel may submit a request for insurance prior to or during the transportation of the parcel.

In some embodiments, there is an indication of pre-authorization of an entity having authority to insure a parcel that is verifiable by one or more entities, systems, and/or nodes. In other words, the indication of pre-authorization may be relied upon by one or more entities, systems, and/or nodes to indicate that a transaction is authorized, even though the transaction is not being generated by a computing device associated with an entity having the authority to insure the parcel (e.g., a smartphone). The indication of pre-authorization may be submitted along with an insurance request 312 and/or a transaction that secures insurance with an insurance provider. For example, in some embodiments, the insurance request 312 may comprise an indication of pre-authorization submitted by the IoT enabled parcel. The submission may thus comprise an indication of pre-authorization of the entity that is verifiable by a one or more entities, systems, and/or nodes.

As described, the indication of pre-authorization may be verifiable. In embodiments, the indication of pre-authorization may be a digital signature and/or may identify a particular data source that indicates that a consumer has authorized the transaction. For example, the request may identify an entity's profile with the ASI-SP 306 that indicates the parcel has the authority to submit an insurance request and initiate an insurance transaction. In some embodiments, the indication of pre-authorization may be through a digital signature, such as a digital signature generated by a private key associated with the consumer. The indication of pre-authorization may be relied upon by insurance provider (or the ASI-SP 306) to initiate an insurance transaction, such as securing an insurance policy. The submission by the parcel can thus facilitate generating an insurance transaction on behalf of an entity having authority to insure the parcel (e.g., a sender, a consignee, and the like).

In certain embodiments, items contained within a parcel may be wirelessly connected, and may be configured to provide wireless connectivity functionality for the parcel while the parcel is being transported by a carrier. For example, an electronic device being shipped may comprise a wireless transmitter (e.g., an RFID tag), a power supply, an on-board memory, and/or the like that may be configured to broadcast parcel information/data while the item remains packaged within the parcel. In certain embodiments, the wireless connectivity components may be disconnected and/or deactivated once the item is removed from the parcel. For example, the wireless connectivity components may be embodied as a separate object placed within the parcel (e.g., secured relative to the packaged item); the wireless connectivity components may be embedded within the item; the wireless connectivity components may form a functional part of the item, and the shipment-specific functionality may be deactivated upon removal from the parcel, and/or the like.

In various embodiments, parcels may be associated with parcel information/data comprising information/data specific to the particular parcel. The parcel information/data may comprise information/data regarding an intended shipping route for the parcel (e.g., an origin, destination, and/or the like), information/data regarding the contents of the parcel (e.g., identifying one or more items stored within the parcel), information/data identifying shipping requirements for the parcel (e.g., a carrier service level, temperature requirements, humidity requirements, shock requirements, and/or the like), an indication of pre-authorization, a tokenized ID of the parcel, and the like. The parcel information/data may be stored in systems comprising one or more distributed ledgers and used to obtain an optimal insurance policy. For example, the ASI-SP may automatically generate an insurance transaction for optimal insurance based on the parcel information/data. Additionally or alternatively, the ACI-RS may automatically resolve an insurance claim based the parcel information/data.

Moreover, the parcel information/data may comprise updated control identifiers and/or digital addresses by providing data indicative of a current identity of an entity, individual, and/or location in control (e.g., possession) of the parcel. For example, the control identifier and/or digital address may indicate that a particular parcel is located on a particular delivery vehicle, at a particular carrier sort location, at a pick-up/transfer/delivery location, and/or the like. The parcel information/data may comprise linking information data configured for use in a distributed ledger/Blockchain environment to link the parcel information/data of a particular transaction or “block” to previously generated transaction/blocks relating to the same and/or different parcel information/data.

### Insurance Selection Platform

Referring now to FIG. 3, an exemplary system diagram of an insurance selection platform (“ASI-SP”) is illustrated in accordance with some embodiments of the present disclosure. It should be appreciated that while FIG. 3 depicts multiple systems, it is contemplated that they may be one single system, in some embodiments. Further, each system may be employed by a computing device, such as computing device 800, server 240, client device 230, and the like. Additionally or alternatively, while ASI-SP 306 is depicted as a separate system, it may operate in a distributed manner such that it is executed by any system and/or one or more computing devices described herein, including a client computing device and/or a computing device associated with an IoT enabled physical asset. It should be appreciated that not all communications between systems are depicted. That is, while several arrows depict communications between particular systems, it is foreseen that each system depicted is communicatively coupled over a network.

In various embodiments, an insurance request 312 having insurance request criteria is obtained by the ASI-SP 306. As used herein, an insurance request may refer to a request to insure the transportation of a physical asset. For instance, the insurance request 312 may be a request for insurance to cover shipping incidents related to the method of transportation (e.g., timing of delivery, service carrier, and methods used for delivery such as air, sea, or land) and/or shipping incidents related to the physical asset itself (e.g., damage, loss of item, and the like).

In various embodiments, the insurance request 312 is stored in an insurance request system 304. The insurance request system 304 can be a distributed ledger that is maintained by at least one node. As such, the insurance request 312 may comprise a digital signature of a computing device generating the transaction. If, for example, the insurance request 312 is generated by the physical asset (such as the IoT enabled parcel), the insurance request 312 may comprise a digital signature that is unique to the IoT enabled physical asset. Additionally or alternatively, the insurance request 312 may be submitted via a user's computing device. As such, the user's computing device may submit the insurance request 312 with a different digital signature (e.g., a signature that is unique to the user's computing device).

As noted, the insurance request 312 may comprise insurance request criteria. At a high level, the insurance request criteria may comprise general shipping conditions, transportation mode and/or route, environmental condition requirements (temperature, pressure, vibration), duration of shipment, general security of the asset (e.g., an enclosed, locked transportation container), policy limits, and parcel identification. More particularly, the insurance request criteria can include a shipment identifier, shipment origin, shipment destination, insurance cost parameters, declared value, shipment content/category, insurance coverage required, optional insurance coverage, logistic provider, logistic provider shipping product, transportation modes, customs information identifier, payment source ID, insurance provider reputation, and the like. The insurance request criteria may also include a weight, size, or value of the physical asset being transported, and a certain threshold in cost for insuring the parcel. In some aspects, the requested criteria are predefined by the consumer, shipper, consignee, and the like.

Further, the insurance request criteria may comprise a criterion associated with the insurer's reputation. The insurer's reputation may be based on any metric used to quantify/qualify an insurer's reputation. For example, the insurer's rating may be based on a numeric rating, such as a numeric rating given by a third-party agency, public entity, consumer, and the like. The insurer's reputation may also be determined based upon ratings or feedback from users' comments (e.g., “poor service,” “prompt payment,” “excellent customer service”). In some embodiments, the insurance provider's reputation can be based on past performance that is automatically generated by the ASI-SP 306. Additionally, the insurer's reputation may be obtained from any source, such as rankings published by news or media outlets, customer reviews, public journals, and the like.

In exemplary embodiments, the ASI-SP 306 selects an insurance policy for the insurance request 312. The insurance policy may generally predefined shipping incidents related to the method of transportation (e.g., timing of delivery, service carrier, methods used for delivery such as air, sea, or land) and/or shipping incidents related to the item itself (e.g., damage, loss of item, and the like). In various embodiments, the insurance provider may submit an insurance offer directly to the ASI-SP 306. For instance, one or more insurance policies may be received through an insurance provider portal in which insurance provider system 302 can interact with the ASI-SP 306. In one embodiment, the insurance provider can interact with a server executing the ASI-SP 306 through a communications network.

In some embodiments, one or more transactions associated with insurance policies may be stored in a distributed ledger. For example, the one or more insurance policies may be submitted by transportation insurers 308 and stored as a transaction on a distributed ledger associated with an insurance offer system 310. Each transaction associated with the one or more insurance policies may comprise a digital signature that is unique to the computing device associated with the transportation insurer 308 such that the node (e.g., node 110n) maintaining the distributed ledger can validate the transaction.

In various embodiments, the insurance policies may be dynamically generated in response to the insurance request. In other words, the insurance policy may be customized to a particular insurance request. For example, the insurance provider system may independently search the insurance request system 304 for a new insurance request 312. Additionally or alternatively, the ASI-SP 306 may communicate any new insurance requests to the insurance provider system 302. It should be appreciated that the ASI-SP may hide or refrain from identifying one or more parameters, such as a requested cost so that the insurance providers may offer their best price for on the insurance request. The insurance provider system 302 can then determine a customized insurance policy in response to the insurance request 312. The customized insurance policy may then be communicated to the insurance offer system 310 for storage on a distributed ledger. In some embodiments, the customized insurance policy can reference the insurance request 312. For instance, the customized insurance policy may include a physical asset identifier, a digital address of the insurance request, a digital address of the insurance requester, a particular request identification number, and the like, as one of the policy parameters. The ASI-SP 306 can then utilize this reference to determine an optimal insurance policy. The term “optimal” may refer to the highest ranked insurance policy. For example, the optimal insurance policy may be the one that most closely matches the user's request.

In some embodiments, the insurance policies may be standardized insurance policies. In other words, the insurance policy may be a typical offering by the insurer to a broad range of consumers. While the standard insurance policy can still reference a digital address of the insurance requester, the standardized insurance policy is generally unaltered from its typical offering. It should be appreciated that the ASI-SP 306 can evaluate both standardized and customized insurance policies in determining an optimal insurance policy.

In exemplary embodiments, the one or more insurance policies can be obtained by searching the transactions on the insurance offer system 310. Additionally or alternatively, the ASI-SP 306 can obtain the one or more insurance policies through a transportation insurance provider and/or its agent systems 302 (e.g., a remote database associated with a server of a transportation insurance provider). Further, the insurance policy may be received from the insurance provider 308 through a web-based portal (not shown). The insurance provider 308 may include, for instance, the service carrier itself and/or a third-party insurance provider.

The insurance policy parameters may relate to the insurer's requirements for insuring the shipment of the physical asset. At a high level, the policy parameters may comprise general shipping conditions, transportation mode and/or route, environmental condition requirements (temperature, pressure, vibration), duration of shipment, general security of the asset (e.g., an enclosed, locked transportation container), policy limits, insurance provider reputation, and physical asset identification. Specifically, the policy parameters may include, for example, an insurance offer identifier, origin, destination, logistic provider(s), transportation mode, cost parameters, payment acceptance ID, insurance coverage limits, included coverage, optional coverage, reputation and rating requirements, covered items and product categories, uncovered items and product categories, uncovered destinations, claim process procedures, proof of loss requirements, and the like. The policy parameters may also include a weight, size, or value of the physical asset being transported, and a certain threshold in cost for insuring the physical asset. In some aspects the insurance policy parameters are predefined by the insurance provider 308.

Additionally or alternatively, the insurance policy parameters may also account for pre-approved insurance requests. For example, if an insurer identifies a particular transaction stored in a distributed ledger requesting insurance, the insurer (or a computer associated with the insurer) may require that the insurance request (or the requesting entity) is pre-approved for automatic insurance policy selection. An insurance request may be pre-approved if the transaction comprises a digital signature that is recognized and approved by the ASI-SP 306. Additionally or alternatively, the ASI-SP 306 may pre-approve the insurance request based on validating one or more request criterion, such as a valid payment mechanism, a valid physical asset identification from a logistics provider, a valid destination, and the like.

The ASI-SP 306 may search the insurance request system 304 automatically and/or in response to a consumer's request received through a user-portal. In some embodiments, the insurance request 312 and/or the request parameters requested criteria can be received through a consumer-facing portal in which the consumer is provided login information. For example, once the consumer has logged in, he or she may interact with a server executing the ASI-SP 306 through a network, utilizing a computing device associated with the consumer to submit an insurance request 312. In some embodiments, the ASI-SP 306 actively monitors the insurance request system 304 for any newly-added insurance requests (such as a new transaction block in a distributed ledger system associated with the insurance request system 304). As such, the ASI-SP 306 may constantly determine whether a new transaction block comprising an insurance request exists and, if so, determine an optimal insurance based on the insurance request criteria contained within the new transaction block.

With continued reference to FIG. 3, in various embodiments, the requested criteria and values of the insurance request 312 are utilized to search one or more insurance policies to identify any insurance policies having policy parameters with similar values. It should be appreciated that the term “similar” could mean an exact match, the term also refers to values within a given range, a predetermined tolerance, and/or a threshold. By way of example, a consumer may have a criterion (e.g. cost of insurance) having a particular value (e.g., “$8.00” or “Willing to pay to up $8.00”). The ASI-SP 306 may utilize this criterion and value to identify any insurance policies having a corresponding policy parameter (e.g., cost of insurance) with a similar value ($7.50). Based on determining that an insurance policy has a corresponding policy parameter with similar values, the insurance policy may be grouped with other insurance policies into a set of insurance policies that may qualify as the optimal insurance policy for shipping the physical asset.

Any insurance request criteria may be used to search and identify an insurance policy having policy parameters with similar values. For example, the insurance request 312 can have criteria based on particular values for a guaranteed delivery time (e.g., overnight delivery), a declared value ($100), and/or an insurance provider's reputation (5 stars). Any insurance policy that includes one or more policy parameters having a similar value (e.g., a policy that covers overnight delivery, a declared value of $100, and/or an insurance provider's reputation of 5 stars) can be included in the set of potential insurance policies. It should be appreciated that any number of insurance request criteria can be used to search and identify insurance policies having at least one corresponding insurance parameter having a similar value.

In some embodiments, the set of insurance policies can be ranked and selected. In some aspects, predetermined weights can be used when comparing the insurance request criteria with the policy parameters and/or when selecting the set of insurance policies. For example, the ASI-SP 306 can rank each insurance policy within the set of insurance policies based on predetermined weights applied to insurance request criteria and/or the insurance policy parameters. In various embodiments, the predetermined weights are predefined by one or more entities (e.g., a shipper and/or insurance provider) and/or systems (ASI-SP 306). In other words, an entity or system can preference a particular criterion within the requested criteria. Similarly, an entity or system can preference an insurance parameter over other policy parameters. The ASI-SP 306 can use these preferences when selecting an optimal insurance policy. For instance, two insurance policies may be considered for a particular insurance request based on having similar values for cost of insurance and policy limit, if the cost of insurance is more heavily weighted (e.g., by the consumer) the insurance policy having a lower cost may be selected over the other insurance policy having a similar policy limit. Additionally or alternatively, an insurance policy that has an insurance policy having a closer value to that of an insurance request criteria can be weighted more heavily than those having more disparate values.

As described, the predetermined weights may be predefined by one or more entities and/or systems. In some embodiments, the predetermined weights can be stored within, or otherwise identified by, the requested criteria. For example, the first set of parameters may define which criterion is more heavily weighted. This may occur, for example, if the consumer assigns a higher weight to the cost parameter of insurance than to a policy limit parameter. If so, the insurance policy that has a similar cost of insurance may be ranked higher than another insurance policy having a similar policy limit. Similarly, in various embodiments, the predetermined weights may be stored within or otherwise identified by a set of parameters associated with the insurance policies. This may occur, for example, if the insuring party assigns a higher weight to a particular logistics provider (e.g., United Parcel Service®) than to a particular shipping method (e.g., must be shipped using air). If so, the insurance policy may be weighted more heavily when it is considered for an insurance request that requests insurance for a similar logistics provider than when it is considered for an insurance request that requests insurance for a particular shipping method.

In some embodiments, the ASI-SP 306 may employ predetermined weights that are predefined by the ASI-SP 306. The predetermined weights may be predefined by using a rule, logic, condition, prediction, pattern inference algorithm, machine learned model, and the like. For example, the ASI-SP 306 may predefine the weights based on historical weight averages for specific insurance policy parameters. The historical averages may be segregated by types of products, modes of transportation, industry and the like. In a further embodiment, the ASI-SP 306 may automatically predefine weights based on historical weights selected by the sender. By using the predetermined weights, the ASI-SP 306 can rank each of the insurance policies even though they may offer different terms of service and/or coverage.

In exemplary embodiments, the ASI-SP 306 can determine an optimal insurance policy (e.g., a more heavily weighted insurance policy) for the insurance request 312. For instance, the ASI-SP 306 may determine the optimal insurance policy based on ranking each insurance policy within the set of one or more insurance policies. For instance, it may be determined that a greater weight should be assigned to the insurance cost rather than to the logistics provider. That is, higher priority may be given to an insurance policy having an insurance policy with an insurance cost that is within the range set by the consumer than an insurance policy requiring a particular logistics provider. Additionally or alternatively, it may be determined that an insurance policy covering a certain mode of transportation (including the route and/or vehicle) should be weighted more heavily than an insurance policy covering a particular logistics provider. Further, it may be determined that a particular policy limit is more important so long as it is within a threshold cost (e.g., a maximum price that a consumer is willing to pay). This may result in ranking policies having greater policy limits higher than insurance policies having a low cost of insurance. For simplicity, reference is made to weighing several insurance request criteria and insurance policy parameters. In reality, the ASI-SP 306 can weigh each requested criterion with each insurance policy parameter, across a plurality of insurance policies. In this way, the ASI-SP 306 may rank each insurance policy within the set of potential insurance policies. In various embodiments, the ASI-SP 306 may use this raking and select the highest weighted insurance policy as the optimal insurance policy. Additionally or alternatively, the consumer can determines the optimal insurance policy based on reviewing the set of one or more potential insurance policies determined by the ASI-SP 306 and submitting a request for the optimal insurance policy to the ASI-SP 306. This, in part, reduces the resources required to independently research and/or independently contact the insurance provider, for example, by visiting a website associated with the insurance company and requesting a quote. Once an insurance policy has been selected, it may be added as a transaction to a distributed ledger (such as a distributed ledger associated with the completed transaction system 314).

In embodiments where the IoT parcel and/or a computing device associated with an IoT enabled parcel automatically determines to request insurance based on detected or determined state information of the parcel, the request may comprise an indication of pre-authorization. The indication of pre-authorization of a particular entity (sender, consignee, etc.) may be relied upon by the ASI-SP 306 or an insuring party to enter into a smart contract. The indication of pre-authorization may include a digital signature of a computing device submitting the request. In exemplary embodiments, the indication of pre-authorization may be stored in a block in one or more distributed ledgers, which can later be referenced in the request for insurance. Additionally or alternatively, the indication of pre-authorization may be stored in a user's profile associated with the ASI-SP 306 system.

In one embodiment, based on determining an optimal insurance policy for the insurance request 312, an electronic insurance transaction can be generated by linking the optimal insurance policy with the insurance request 312. Accordingly, an electronic, immutable record can be made that memorializes the transaction between the consumer and the insurance provider offering the optimal insurance policy. Even more, this electronic record could be memorialized as a self-executing, smart contract. As such, the smart contract may address the policy parameters of the optimal insurance policy and parcel shipping information. The insurance transaction can be memorialized in the form of a particular “block” (e.g., an insurance transaction block) in the one or more distributed ledger, such as a completed transaction distributed ledger associated with the completed transaction system 314. In some aspects, the ASI-SP 306 generates the transaction using a digital signature that is unique to the ASI-SP 306 system and communicates the transaction to one or more nodes of a distributed network. Additionally or alternatively, each transacting party (e.g., the shipper and insurance provider) sign the transaction using a digital signature that is unique to them.

In one embodiment, the insurance transaction block can be linked to the optimal insurance policy block and/or the insurance request block. For example, the insurance transaction block may be linked using a cryptographic hash of information associated with the insurance policy block and/or the insurance request block. In exemplary embodiments, the insurance transaction cryptographic hash may utilize a time-stamp and/or information associated with the insurance request 312 and/or the insurance policy (e.g., the terms of the insurance policy stored within the insurance policy block) in order to create the insurance transaction cryptographic hash. In further embodiments, the insurance transaction block can be linked by including one or more a digital addresses and/or a unique identifiers associated with the optimal insurance policy block and/or the insurance request block. As such, neither party is able to manipulate the insurance policy block and/or the insurance request block without destroying the insurance transaction block and any subsequent blocks. This, in part, allows for two otherwise potentially anonymous parties (e.g., the consumer and the third-party insurer) to enter into a secured electronic transaction over a network that cannot be manipulated by either party. As described, this overcomes several deficiencies with prior technology whose electronic transactions are generally susceptible to manipulation.

In various embodiments, the ASI-SP 306 obtains parcel information/data collected by one or more sensors associated with the parcel. For example, the ASI-SP 306 may search one or more distributed ledgers to obtain the parcel information/data. In one embodiment, the one or more sensors are physically coupled to the parcel. In a further embodiment, the parcel information/data is received from sensors in proximity to the parcel (e.g., a temperature sensor attached to a delivery vehicle that measures storage temperatures of the parcel). The one or more sensors may detect light, moisture, temperature, acceleration, location (e.g., GPS coordinates) and other conditions experienced by the parcel.

In various embodiments, the parcel information/data comprises information beyond sensor data. For example, the parcel information/data may comprise information/data regarding an intended shipping route for the parcel (e.g., an origin, destination, and/or the like), information/data regarding the contents of the parcel (e.g., identifying one or more items stored within the parcel), information/data identifying shipping requirements for the parcel (e.g., a carrier service level, temperature requirements, humidity requirements, shock requirements, and/or the like). The parcel information/data may be utilized to automatically apply various smart contracts upon determining whether the terms of the optimal insurance policy that has been selected (i.e., a selected insurance policy) have been met.

Moreover, the parcel information/data may comprise updated control identifiers providing information/data indicative of a current identity of an entity, individual, and/or location in control (e.g., possession) of the parcel. For example, the control identifier may indicate that a particular parcel is located on a particular delivery vehicle, at a particular carrier sort location, at a delivery location, and/or the like. As discussed herein, the one or more sensors associated with the parcel may be utilized to provide real-time information so that the insurance coverage can be dynamically modified (e.g., by obtaining additional coverage) while the parcel is in transit. Some embodiments, may determine that a present or future condition of the parcel (e.g., its environmental conditions, location, mode of transportation, and the like) exceeds a threshold defined by a predefined criteria (which may correspond to an insurance request parameter) based on sensor data received from at least one sensor. For instance, if the parcel state indicates that the parcel is being re-routed based on acquired location data not aligning to a predefined route, then embodiments may allow for obtaining insurance coverage before and after the parcel is shipped by a sender.

In exemplary embodiments, the ASI-SP 306 monitors the parcel information (such as that which is stored in one or more parcel information blocks within one or more Blockchain repositories) and detects a travel condition. The travel condition may comprise one or more events that were not anticipated by either the third-party insurer and/or the consumer. The unexpected event may increase and/or decrease the risk of transporting the parcel. For instance, the parties may have anticipated a particular route for the parcel. The ASI-SP 306 may monitor the particular route for weather patterns (e.g., storms, tornadoes, hurricane, and the like) and compare that to the current location of the parcel stored in the parcel information block. As such, the ASI-SP 306 may determine that the parcel is at risk of being lost or damaged due to the weather patterns. As a further example of a travel condition, the ASI-SP 306 may monitor the parcel information blocks to determine whether the storage temperature of the parcel has materially changed, creating a risk that the item within the parcel could spoil. In yet another example, the ASI-SP 306 may monitor the GPS location of the parcel to determine that the parcel is being re-routed if the parcel location does not match the anticipated route. In this way, the ASI-SP 306 can determine that an unexpected travel condition has occurred.

In various embodiments, based on the unexpected travel condition occurring, the insurance coverage on the parcel can be automatically entered into, modified, and/or expanded. For instance, as described, the ASI-SP 306 can determine the GPS location of the parcel and, as such, determine if the parcel is being re-routed if the parcel location does not match the anticipated route. Further, the re-routing of the parcel may increase the risk of damage to and/or loss of the parcel. As such, the ASI-SP 306 can evaluate the risk involved in the unexpected travel condition and can automatically modify and/or expand the insurance coverage to include the unforeseen risk associated with re-routing the parcel. In one non-limiting example, if the ASI-SP 306 determines there is an increased risk of damage to and/or loss of the parcel, the ASI-SP 306 can then identify a second optimal insurance policy to cover the increase in risk. In a further example, the ASI-SP 306 may secure additional insurance policy to cover the increased risk. It is foreseen that, in exemplary embodiments, the ASI-SP 306 may alert one or more parties (e.g., the consumer, the third-party insurer, and/or a second third-party insurer) as to the modification and may wait for their confirmation for the modification. It should be appreciated that the modified insurance coverage can be stored as a new “block” in the existing Blockchain. As discussed above, the insurance transaction block may immutable and cannot be changed without destroying the existing Blockchain. As such, the insurance modification and/or expansion may be stored as an insurance modification block that is linked to the insurance transaction block.

### Automatic Insurance Selection

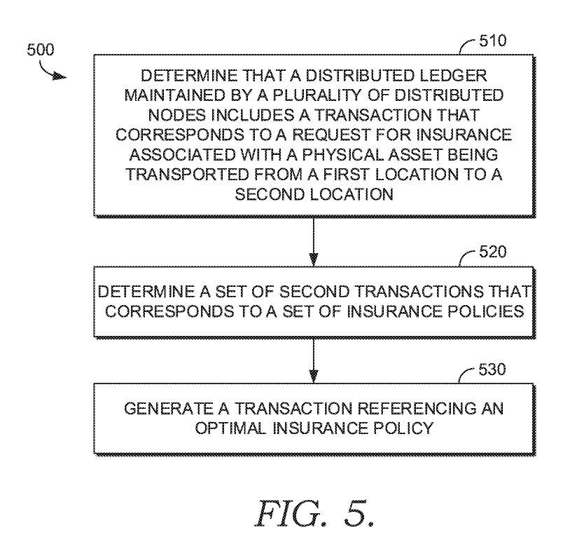

Turning to FIG. 5, an exemplary flow diagram of a method 500 for automating the selection of insurance policies is illustrated in accordance with some embodiments of the present disclosure. The ASI-SP 306 may automatically select an optimal insurance policy based on data from one or more systems and/or distributed ledgers described herein, such as the one or more systems depicted in FIG. 3. As described herein, the ASI-SP 306 may be employed at a server, a user computing device, and/or an physical asset (e.g., IoT parcel). At step 510, a computing device (e.g., a server associated with the ASI-SP 306) determines that a distributed ledger maintained by a plurality of distributed nodes includes a transaction that corresponds to a request for insurance associated with a physical asset being transported from a first location to a second location. In embodiments, the ASI-SP 306 may search one or more distributed ledgers, such as the one or more distributed ledgers may be maintained in the insurance request system 304, for a transaction including a request for insurance covering a physical asset being transported. As described above, the request for insurance may be generated and communicated by computing device (e.g. a user's mobile device and/or IoT enabled parcel). In embodiments, the insurance request may be generated for storage on one or more distributed ledgers associated with the insurance request system 304. Additionally or alternatively, the insurance request may be communicated by the computing device to a node (e.g., node 110n) for storage on the one or more distributed ledgers associated with the insurance request system 304.

In various embodiments, the ASI-SP 306 may continuously and/or automatically search the insurance request transaction system to determine if any new requests have been added. Upon identifying a newly added insurance request transaction block, it may be determined that the request is an open request. For example, the ASI-SP may determine whether the added insurance request transaction block is an open request based on searching a completed transaction system 314 and determining if there is a reference to an insurance policy block. For example, the completed transaction system 314 may comprise a distributed ledger including a transaction (e.g., a smart contract) referencing the insurance request transaction block, the insurance request criteria, and/or physical asset identification. If there is no reference, then there the insurance request transaction block may be identified as an open request.

At step 520, a set of second transactions that corresponds to a set of insurance policies is determined. In various embodiments, the ASI-SP 306 searches one or more distributed ledgers, such as a distributed ledger associated with the insurance offer system 310, for a set of second transaction blocks comprising a set of insurance policies submitted by transportation insurers 308, as shown in FIG. 3. In some embodiments, each second transaction is associated with an insurance policy that may be generated by a computing device associated with an insurance provider system 302. The generated transaction may then be communicated by a computing device to a node (e.g., node 110n) for storage on the one or more distributed ledgers associated with the insurance offer system 310.

The set of insurance policies may comprise standardized insurance policies and/or customized insurance policies, as described above. The customized insurance policy may include an insurance policy that is dynamically created based on a requested criteria. This may occur, for instance, if an insurance policy transaction was specifically generated and stored in response to a particular insurance request. The insurance policy may then reference the transaction associated with a request for insurance. For example, the customized insurance policy may reference an insurance request, for example, through a digital address, a parcel identification, a particular request identification number, and the like.

In some embodiments, the ASI-SP 306 can utilize the insurance request criteria and their values to identify an optimal insurance policy. The optimal insurance policy may be the highest weighted insurance policy that has parameters with similar values as the insurance request criteria. For example, the insurance policy may cover shipping incidents related to the method of transportation (e.g., timing of delivery, service carrier, methods used for delivery such as air, sea, or land) and/or shipping incidents related to the item itself (e.g., damage, loss of item, and the like) that correspond to an insurance transaction (i.e., the first transaction) requesting same method of transportation and covered shipping incidents.

At step 530, a third transaction is generated based on selecting the optimal insurance policy. For example, the third transaction may initiate a smart contract which references one or more insurance parameters of the optimal insurance policy. In embodiments, a computing device associated with a parcel and/or a computing device associated with the ASI-SP 306 can generate a transaction and then communicate that transaction to at least one node of the plurality of distributed nodes for storage into a distributed ledger, such as a distributed ledger associated with a completed transaction system 314.

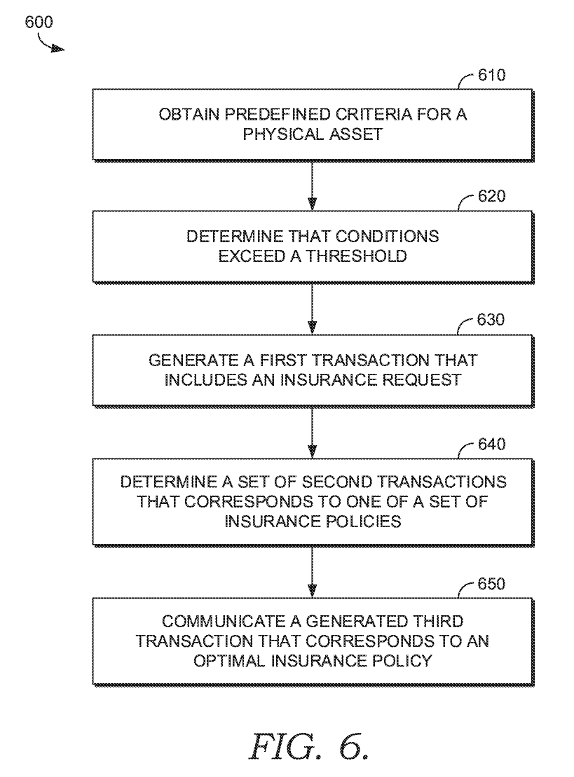

In exemplary embodiments, insurance coverage may be secured after the physical asset has been shipped. Referring now to FIG. 6, an exemplary flow diagram of a method 600 for automating the selection of insurance policies is illustrated in accordance with some embodiments of the present disclosure. In certain embodiments, method 600 may be employed the IoT enabled parcel in communication with a server employing the ASI-SP 306. In some embodiments, method 600 is employed by the ASI-SP 306 as it may monitor the state of the parcel. At step 610, a predefined criteria for a physical asset is obtained. In various embodiments, the predefined criteria may be set by the user. Additionally or alternatively, the ASI-SP 306 may determine the predefined criteria. For example, if a user is shipping a physical asset that needs to be refrigerated, then the user and/or the ASI-SP 306 may set the predefined criteria as 32-40 degrees. The predefined criteria may be stored locally on the IoT enabled parcel and/or any system described herein. Additionally or alternatively, the predefined criteria may be stored at a remote server, such as a server employing the ASI-SP 306. In embodiments, the predefined criteria may be similar to the insurance request criteria. For instance, the predefined criteria may relate to general shipping conditions, transportation mode and/or route, environmental condition requirements (temperature, pressure, vibration), duration of shipment, general security of the asset (e.g., an enclosed, locked transportation container), and the like. In addition, the predefined criteria may include an indication of pre-authorization for initiating a transaction requesting insurance. The predefined criteria may be obtained from one or more databases and/or distributed ledgers.

In some embodiments, a computing device (e.g., the IoT parcel and/or the server associated with the ASI-SP 306) is in communication with at least a first sensor that is operable to detect a state of the parcel. The state of the parcel generally refers to the condition of the parcel at a particular moment in time. As such, the state of the parcel comprises any environmental condition, physical location and/or orientation, entity in possession of the parcel, and the like, at a particular moment in time. Accordingly, the sensor may be physically coupled to the parcel and/or may be a sensor that is proximate the parcel (e.g., a sensor associated with transportation vehicle and/or a storage facility).

At step 620, in various embodiments, the computing device determines whether a present or future environmental conditions (and/or the state of the parcel) exceeds a threshold included in the obtained predefined criteria based on sensor data received from one or more sensors. For example, if the predefined criteria is that a physical asset should be refrigerate, a threshold temperature may be set based on the required temperature of the storage environment (e.g., with a transportation vehicle or storage facility). Specifically, the threshold temperature may be set for 45° F. If sensor data, either from a sensor physically coupled to the parcel or a sensor within the storage environment, indicate that the temperature has reached 45° F., then the computing device may determine that the present environmental condition of 32-40° F. has exceeded the threshold. The computing device may thus determine that there is an increased risk that the item within the parcel could spoil. As a further example, the computing device may determine whether location data of the parcel corresponds to an unexpected shipping route. If so, it may determine that the location data exceeds a threshold geo-fence. In addition, a computing device can forecast a new delivery route and determine potential future states of the parcel associated with the new delivery route in relation to any increased risks (e.g., a delay in delivery, impending storms on new delivery route, and the like). In some embodiments, the computing device further relies on data collected from one or more external sources (social media websites, news outlets, weather forecasts, logistic network data, and the like) that are relevant to the new, forecasted delivery route.

At step 630, a first transaction that includes an insurance request is generated. In various embodiments, the insurance request may be generated by the IoT parcel. Additionally or alternatively, the ASI-SP 306 may generate the transaction. The first transaction that includes an insurance request having insurance request criteria and an indication of pre-authorization that are based on the obtained predefined criteria. The insurance request criteria may comprise a shipment identifier, shipment origin, a current location, shipment destination, insurance cost parameters, declared value, shipment content/category, insurance coverage required, optional insurance coverage, logistic provider, logistic provider shipping product, remaining transportation modes, customs information identifier, payment source ID, insurance provider reputation, and the like. The first transaction may be communicated over a network to one or more nodes that collectively maintain a distributed ledger. In some embodiments, the request for insurance is digitally-signed with a unique key associated with the computing device generating the request (e.g., a unique key associated with an IoT enabled parcel).

At step 640, a set of second transactions corresponding to one of a set of insurance policies may be determined by the ASI-SP 306. The set of second transactions may be stored in a distributed ledger, such as a distributed ledger associated with the insurance provider system 302, is maintained by a node 110n. In various embodiments, the ASI-SP 306 may search the maintained distributed ledger to determine that the distributed ledger includes a set of second transactions that each corresponds to one of a set of proposed insurance policies. The proposed insurance policy may be generated by the insurance provider system 302 using a digital signature unique to the ASI-SP 306 and then communicated to a node for addition to a distributed ledger associated with the insurance offer system 310. The proposed insurance policies may include one or more policy parameters having similar values as the insurance request criteria that was submitted. For example, the one or more policy parameters may include many of the same terms or options of insurance coverage as memorialized in the insurance request. The insurer's options may include, for example, an insurance offer identifier, origin, destination, logistic provider(s), transportation mode, cost parameters, payment acceptance ID, insurance coverage limits, included coverage, optional coverage, reputation and rating requirements, covered items and product categories, uncovered items and product categories, uncovered destinations, claim process procedures, proof of loss requirements, and the like. Additionally or alternatively, each transaction in the set of transaction may reference the insurance request transaction. For instance, the transaction may rely on a digital address and/or a unique identifier.

At step 650, a generated third transaction that corresponds to a selected insurance policy is communicated. In some embodiments, the computing device may employ predetermined weights to determine an optimal insurance policy. For example, an optimal insurance policy may be determined based on predetermined weights applied to insurance request criteria and/or the insurance policy parameters of each policy. The predetermined weights may be predefined by one or more entities and/or systems. For example, the predetermined weights may be predefined by an insurance selection platform (e.g., ASI-SP) and may be a decision logic comprising a rule, logic, condition, prediction, pattern inference algorithm, machine learned model, and the like. Weights may also be predefined by the user such that the weights are applied to the different parameters based on the relative importance of particular to the consumer. As such, the predetermined weights may be predefined and included in the insurance request criteria. For instance, a consumer may assign a greater weight to the insurance cost than to a particular logistic provider.

The proposed insurance policy may be ranked such that an optimal insurance policy may be selected. In exemplary embodiments, the optimal insurance policy will be selected based on having policy parameters that are more heavily weighted than other insurance policies having policy parameters that are not as heavily weighted. It should be appreciated that the insurance policy having a greater number of policy parameters that match the insurance request criteria (e.g., because they have similar values) may be weighted more heavily than an insurance policy having fewer matching policy parameters.

After selecting an optimal insurance policy, a computing device (e.g., the server associated with the ASI-SP 306, IoT enabled parcel, and/or consumer device) may then generate a transaction comprising the terms of the optimal insurance policy. The generated transaction can then be communicated, over a network, to a node that maintains a distributed ledger, such as a distributed ledger that is associated with a completed transaction system. In some embodiments, the second generated transaction is digitally-signed with the unique key associated with the computing device generating the transaction. For example, if the computing device associated with the parcel generating the transaction, it may digitally sign the transaction. If the ASI-SP 306 generates the transaction, it may digitally sign the transaction with a unique key associated with the server executing the ASI-SP 306. In various embodiments, electronic notifications are communicated to various transacting entities notifying them that the optimal insurance policy has been selected. For instance, an electronic communication may be sent to a computing device associated with a sender that the second generated transaction has been communicated to the node.

### Automatic Claim Resolution

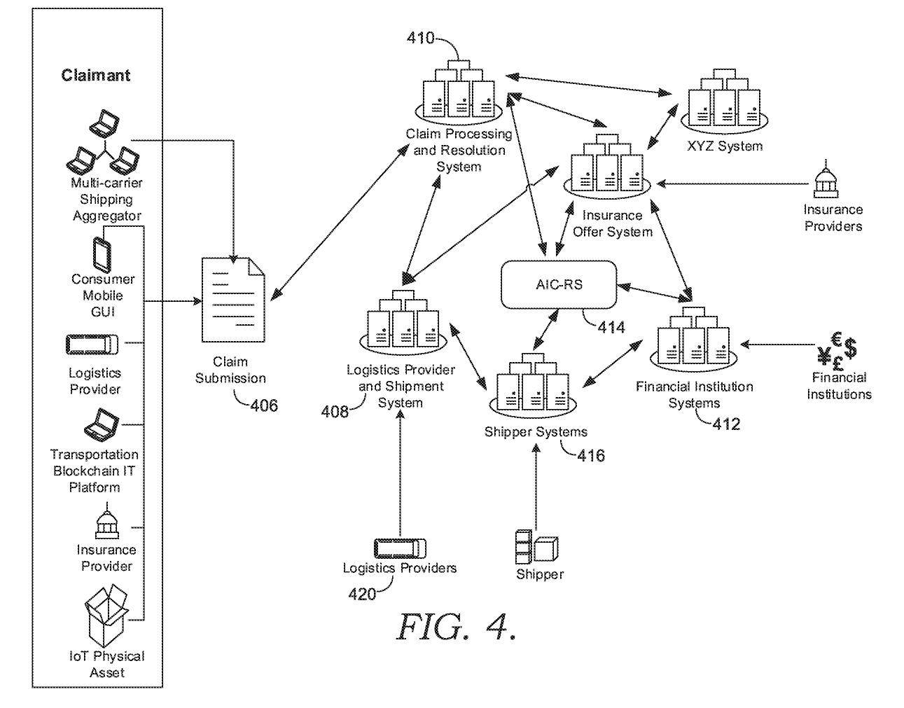

As described herein, various embodiments may resolve an insurance claim. Exemplary aspects include an insurance claim resolution system that can resolve insurance claims for an insurance transaction, such as an insurance transaction that is stored on the distributed ledger associated with completed transaction system 314. The insurance claim resolution system can be an automated system that resolves claims with minimal to no human interaction (e.g., an automated insurance claims resolution system, referred to herein as “AIC-RS”). For example, the AIC-RS 414 may automatically determine whether there is a basis for a claim and resolve the claim based on shipping information (e.g., partial information/data) related to the parcel at issue. The AIC-RS 414 may be employed at a server that is in communication with one or more systems to resolve a claim, as illustrated in FIG. 4.

At a high level, a claim 406 can be submitted by a claimant and stored in a claim processing system 410. For example, the claim can be submitted by a user device and/or an IoT parcel. The insurance claim may be a request to enforce a completed insurance transaction. In some embodiments, the insurance claim 406 may be a request to execute a smart contract.

In various embodiments, the AIC-RS 414 can be notified that a claim is pending in a claim processing and resolution system 410. For example, the claim may be submitted via a user portal associated with the AIC-RS 414, which automatically notifies the AIC-RS 414 to process the claim. Additionally or alternatively, the claim processing and resolution system 410 may notify the AIC-RS 414 once the claim is received.

The AIC-RS 414 can access the claim processing and resolution system 410 to retrieve and analyze the claim. The AIC-RS 414 may analyze the claim to determine whether the claim is a valid claim. For instance, the AIC-RS 414 may determine whether the claim 406 is a duplicate claim and/or if the claim is digitally signed by a computing device that is associated with a party to the insurance transaction being enforced.

The AIC-RS 414 may determine relevant data to resolve the claim. The AIC-RS may determine the relevant data based on the information provided by the claim. In various embodiments, the claim identifies the source for the relevant data. For example, the claim may reference (e.g., through a digital address) the insurance transaction stored within the completed transaction system 314. Because each of the parcel information/data, insurance request, insurance offer, and insurance transaction may be linked or referenced across one or more sources and/or one or more distributed ledgers, the AIC-RS 414 determine relevant data (e.g., the insurance transaction terms, the state of the parcel, delivery dates, travel route, and the like) for resolving claim. In exemplary embodiments, the AIC-RS 414 may search a logistics provider and shipment system 408 that stores data associated with a logistics network that transported the physical asset. For instance, logistics provider and shipment system 408 may store data associated with a shipping route traveled by the delivery vehicle (as indicated by a GPS system associated with the delivery vehicle), identification of entity or vehicle having possession of the parcel, environmental conditions of a storage facility, and the like. Additionally or alternatively, the AIC-RS 414 may request that a return label be generated by the logistics provider and shipment system 408 in the event that the physical asset must be returned.

With continued reference to FIG. 4, the AIC-RS 414 may be in communication with the shipper system 416. In various embodiments, the shipper system may be associated with an entity shipping a physical asset. The AIC-RS 414 may communicate with the shipper system 416 in the event a replacement is required by the terms of the insurance policy, for example.

The AIC-RS 414 may also be in communication with a financial institution system 412. In some embodiments, the financial institution system 412 may be associated with any entity providing financial services to the transacting entities. By way of example only, the financial institution system 412 may be associated with an organization, such as a bank and/or credit union, where the transacting parties (e.g., the insurance requestor and insurance provider) maintain personal and/or corporate accounts. The financial institution system 412 may also be associated with an entity providing services to facilitate payments between one or more entities, such as an escrow service.

It should be appreciated that while FIG. 4 depicts multiple systems in communication with other systems, it is contemplated that they may be one single system. In addition, not all communications between systems are depicted. That is, while several arrows depict communications between particular systems, it is contemplated that each depicted system is in communication over a network. Further, each system may be employed by a computing device, such as the computing device depicted in FIG. 8. Additionally or alternatively, while AIC-RS 414 is depicted as a separate system, it may operate in a distributed manner such that it is executed by any system or computing devices described herein, including a client computing device and/or a computing device associated with an IoT enabled parcel.

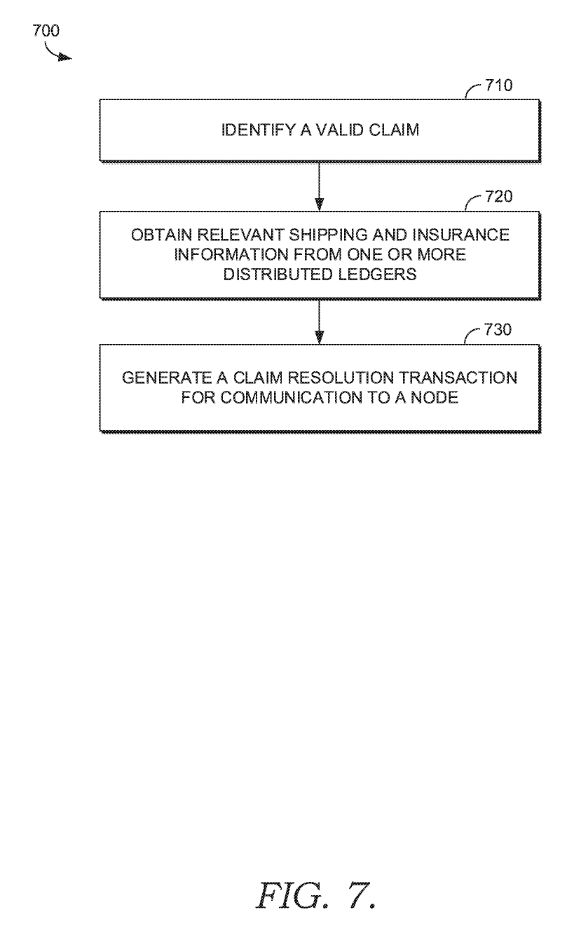

In accordance with the illustration of FIG. 4, FIG. 7 depicts an exemplary flow diagram of a method 700 for resolving a claim in accordance with some embodiments of the present disclosure. The method 700 may be carried out by a server employing the AIC-RS 414. The AIC-RS 414 may comprise one or more components to carry out each step for resolving a claim. At step 710, a valid claim is identified by a claim confirmation component of an insurance claim resolution platform (such as the platform depicted in FIG. 4). The claim confirmation component may first identify that a claim was submitted by receiving the claim from a submitting entity. Additionally or alternatively, the claim may be identified from determining that a claim submission transaction was added to one or more distributed ledgers. For example, as shown in FIG. 4, a claim submission 406 may be stored in the claim processing and resolution system 410, which is then searched by the AIC-RS 414. The claim itself may be submitted by any systems, sources, and/or entities described herein, including a consumer, consignee, shipper, logistics provider, ASI-SP, and the like. As shown in FIG. 4, the claim 406 may be submitted by any entity, such as a multi-carrier shipping aggregator, a consumer mobile device, a logistics provider, a transportation Blockchain IT platform, an IoT Asset, and an insurance provider.

In various embodiments, the claim 406 is submitted by the IoT parcel or a computing device associated with the parcel. For example, a computing device associated with the IoT enable parcel may submit a claim based on detecting a transportation event. The transportation event may relate to a change in the state of the parcel, including changes in environmental conditions and/or travel conditions, the occurrence of a shipping incident associated with the parcel, and the like. As described herein, the state of the parcel may be detected by one or more sensors associated with the parcel and/or proximate to the parcel. A computing device associated with the IoT parcel may rely on the transportation event and utilize claim submission decision logic comprising a rule, logic, condition, prediction, pattern inference algorithm, machine learned model, and the like, to determine whether or not to submit a claim. For example, the claim submission decision logic may determine that the change in temperature of the transportation vehicle is not covered by an insurance policy. Accordingly, the claim submission decision logic may not submit a claim. As a further example, the IoT parcel may detect (e.g., through a location sensor) that it has arrived to its destination and log the date and time of delivery. In turn, the claim submission logic may retrieve this data and determine that the actual delivery date is past the expected date of delivery covered by a policy parameter and, thus, automatically submit the claim with minimal to no human interaction.

Once a claim 406 has been identified, the claim confirmation component may confirm that the claim is valid. The claim may be valid if it is determined that a duplicate claim does not exist. Additionally or alternatively, the claim 406 may be valid if a search of one or more systems (e.g., a distributed ledgers such as a parcel information/data distributed ledger, an insurance request distributed ledger, and/or an insurance offer distributed ledger) reveals that there is a record of a shipment of the parcel and that the parcel has been insured (e.g., whether the parcel associated with a smart contract related to insurance coverage). In certain embodiments, the validation of the claim may be stored on one or more distributed ledgers. For example, the AIC-RS 414 may generate a transaction associated with validation of the claim 406, where the generated transaction identifies the relevant information and/or systems (e.g., a completed transaction system 314) that can substantiate the claim. This transaction can then be communicated to a node for validation and addition to a distributed ledger.

At step 720, the AIC-RS 414 may search data stores, repositories, distributed ledgers, and databases to obtain the relevant shipping information and insurance policy information that is used during the claims resolution process (if it has not already been provided by the claim submission 406). As such, the AIC-RS 414 may determine the relevant data and their sources so that a node can determine whether a claim is valid. For example, the AIC-RS 414 may have a claim resolution component that searches/queries systems and their databases, and/or distribute ledgers, for information associated with resolving a claim (e.g., one or more parcel information blocks, one or more insurance transaction blocks, one or more insurance request blocks, the ASI-SP 306, and one or more smart contracts relating to an optimal insurance policy) in order to identify relevant claim resolution data.

In some embodiments, the claim resolution component initially identifies the policy parameters of an insurance policy that has been memorialized so as to identify the relevant data for executing the smart contract. For example, if the parameters of a smart contract require that a certain route be used in the transportation of the parcel, the claim resolution component may search the appropriate systems and/or ledger for the location data (i.e., GPS locations of the parcel throughout the transportation of the parcel). The claim resolution component can thus obtain logistics provider's information regarding the location of the parcel by searching a logistics provider and shipment system 408, as shown in FIG. 4. Additionally or alternatively, the claim resolution component may verify that the location stored in the logistics provider and shipment system 408 corresponds to the location detected by the one or more sensors associated with the IoT enabled parcel. Similarly, the resolution component may determine that the smart contract requires sensor data relating to environmental conditions to determine whether the temperature fell below a certain threshold. The resolution component may then search parcel information/data relating to environmental conditions that is stored in one or more systems storing parcel information/data (e.g., a distributed ledger associated with a logistics provider and shipment system 408) to determine the location of the relevant data. The claim resolution component can then generate a request that points to the appropriate sources of the location data and/or environmental conditions, thereby identifying the relevant sources of data for a node to rely upon when executing the smart contract.

In additional embodiments, the claim resolution component may use references within the blocks and/or the digital addresses to identify relevant claim resolution data. Because blocks within one or more distributed ledgers can be linked to other blocks in other distributed ledgers, this information can be used to identify which systems and/or distributed ledgers to search. For example, the AIC-RS 414 may identify the relevant insurance request block from the smart contract and then search any block linked to the insurance request block to identify further systems to search (e.g., a block within a logistics provider and shipment system 408 and/or a distributed ledger storing sensor data associated with the parcel). In this way, embodiments can search one or more systems and/or distributed ledgers for relevant claim resolution data in a more efficient manner, conserving computing resources.

Relevant claim resolution data includes, but is not limited to, shipment information, insurance information, parcel information/data, and/or information associated with the claim itself. For example, the shipment information may comprise a shipment identifier, origin, destination, insured value, shipment content/category, hidden procedures, and the like. The insurance information may comprise an insurance policy identifier, origin or origin list/region, logistics provider coverage, transportation mode coverage, cost, payment acceptance ID, insurance coverage limits included coverage, optional coverage, covered items and product categories, uncovered items and product categories, uncovered destination, claims process, proof of loss requirements, customs information, hidden procedures, and the like. Parcel information/data may comprise environmental conditions, the state of the parcel throughout transportation, sensor data, chain-of-possession, transportation route, and the like. Information associated with the claim itself may comprise a claim identifier, shipment identifier, insurance identifier, complaint type, expected resolution, claim amount, evidence, description of the damage, hidden procedures, and the like.

At step 730, a claim resolution transaction can be generated for communication to a node. The claim resolution transaction can be generated by the AIC-RS 414 based on relevant shipping information, parcel information/data, and insurance policy information. In some embodiments, a resolution component can determine if all necessary information is obtained such that a node can determine whether the policy parameters of the insurance policy (e.g., the optimal insurance policy selected by the ASI-SP 306) are violated or satisfied. If not, any further relevant data can be obtained. In exemplary embodiments, the AIC-RS 414 obtains further relevant claim resolution data by searching one or more distributed ledgers. For instance, if a claim submission 406 does not contain the relevant information, the AIC-RS 414 may determine that additional information is required for a node to execute the contract. In some embodiments, the resolution component may require further information from one or more entities (e.g., a consumer, a consignee, a shipper, the entity receiving the physical asset) and/or systems (the logistics provider and shipment system 408, the financial institution system 412, the claim processing and resolution system 410, the insurance provider system 302, and the like). Accordingly, a communication may be generated and transmitted to the appropriate entities and/or systems to obtain additional shipping information. The additional shipping information can then be used to resolve the claim.

The generated request may identify the relevant sources of data stored within a system or distributed ledger so that the smart contract may be executed. As a node may only determine whether the terms smart contract have been satisfied, the AIC-RS 414 may assist the node by obtaining the relevant data and providing digital addresses to one or more systems and/or distributed ledgers that can be referenced by the node in executing the smart contract. Once generated, the claims resolution transaction can be communicated to a node, which then executes the smart contract.

In various embodiments, once a smart contract is executed, a claim-resolution action may be generated. This may be generated by the AIC-RS 414 or automatically triggered by the smart contract. By way of example, the claim-resolution action can be disbursing a payment (e.g., currency or cryptocurrency) from a financial institution system 412, generating a return shipping label (e.g., by a logistics provider and shipment system 408), generating a communication to be delivered to the appropriate parties regarding the resolution of the claim, issuing a replacement shipment (e.g., by communicating with a shipper system 416), and the like. As described, in some embodiments, the execution of the smart contract may automatically trigger a claim-resolution action. For instance, if the smart contract has a predefined claim-resolution action such as disbursing a payment for a delayed delivery embedded within the smart contract, then based an indication that there was a delayed delivery in one or more systems and/or distributed ledgers, the smart contract may automatically disburse a payment. Additionally or alternatively, the resolution component of the AIC-RS 414 may determine any claim-resolution actions to be taken.

Having described embodiments of the present invention, an exemplary operating environment in which embodiments of the present invention may be implemented is described below in order to provide a general context for various aspects of the present invention. Referring to FIG. 8 in particular, an exemplary operating environment for implementing embodiments of the present invention is shown and designated generally as computing device 800. Computing device 800 is but one example of a suitable computing environment and is not intended to suggest any limitation as to the scope of use or functionality of the invention. Neither should the computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes a bus 810 that directly or indirectly couples the following devices: memory 812, one or more processors 814, one or more presentation components 816, input/output (I/O) ports 818, input/output components 820, and an illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 8 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer-storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be equipped with depth cameras, such as stereoscopic camera systems, infrared camera systems, RGB camera systems, touchscreen technology, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

The present technology has been described in relation to particular embodiments, which are intended in all respects to be illustrative rather than restrictive. Alternative embodiments will become apparent to those of ordinary skill in the art to which the present technology pertains without departing from its scope. Different combinations of elements, as well as use of elements not shown, are possible and contemplated. It will be understood that certain features and sub-combinations are of utility and may be employed without reference to other features and sub-combinations. This is contemplated by and is within the scope of the claims.

What is claimed is:

1. A computer-implemented method for automating selection of insurance policies for physical assets, the method comprising:
determining, by a computing device, that a distributed ledger maintained by a plurality of distributed nodes includes a first transaction that corresponds to a request for insurance associated with a physical asset being transported from a first location to a second location, the request comprising a first set of parameters for the insurance request;
determining, by the computing device, that the distributed ledger includes a set of second transactions that corresponds to a set of insurance policies that each reference the first transaction, each transaction in the corresponding set of second transactions having insurance policy parameters that are determined based on insurance request criteria; and
generating, by the computing device, a transaction that is communicated to at least one node of the plurality of distributed nodes for storage into the distributed ledger, the generated transaction referencing an optimal insurance policy selected from the set of insurance policies based on predetermined weights.

2. The computer-implemented method of claim 1, wherein the first transaction further includes a digital token identifying the physical asset.

3. The computer-implemented method of claim 2, wherein the predetermined weights are predefined by the insurance request criteria.

4. The computer-implemented method of claim 1, wherein the generated transaction identifies at least one of the first transaction or the second transaction.

5. The computer-implemented method of claim 1, wherein the first transaction is digitally signed by a first unique key associated with a computing device associated with an entity either sending or receiving the physical asset.

6. The computer-implemented method of claim 1, wherein each second transaction is digitally signed by a second unique key associated with a computing device of an insurance provider.

7. The computer-implemented method of claim 1, wherein the generated transaction is digitally signed with a third unique key associated with a computing device of an insurance selection platform.

8. A system comprising:
one or more processors; and
computer storage memory having computer-executable instructions stored thereon which, when executed by the processor, implement a method for automating selection of insurance policies for physical assets, the method comprising:
determining, by a computing device, that a distributed ledger maintained by a plurality of distributed nodes includes a first transaction that corresponds to a request for insurance associated with a physical asset being transported from a first location to a second location, the request comprising criteria for the insurance request;
determining, by the computing device, that the distributed ledger includes a set of second transactions that corresponds to a set of insurance policies that each reference the first transaction, each transaction in the corresponding set of second transactions having insurance policy parameters that are determined based on the insurance request criteria; and
generating, by the computing device, a transaction that is communicated to at least one node of the plurality of distributed nodes for storage into the distributed ledger, the generated transaction referencing an optimal insurance policy selected from the set of insurance policies based on predetermined weights.

9. The system of claim 8, wherein the first transaction further includes digital token identifying the physical asset.

10. The system of claim 9, wherein the predetermined weights are predefined by the insurance request criteria.

11. The system of claim 8, wherein the generated transaction identifies at least one of the first transaction or the second transaction.

12. The system of claim 8, wherein the first transaction is digitally signed by a first unique key associated with a computing device of a sender.

13. The system of claim 8, wherein each second transaction is digitally signed by a second unique key associated with a computing device of an insurance provider.

14. The system of claim 8, wherein the generated transaction is digitally signed with a third unique key associated with an insurance selection platform.

15. The system of claim 8, wherein the physical asset is an IoT enabled parcel.

16. A computer-implemented method for automating selection of insurance policies for physical assets comprising:
obtaining, by a computing device associated with a parcel, predefined criteria for a physical asset contained within the parcel, wherein the computing device is coupled to at least a first sensor operable to detect a state of the parcel;
determining, by the computing device, that a present or future environmental condition of the parcel exceeds a threshold included in the obtained predefined criteria based on sensor data received from the first sensor;
generating, by the computing device, a first transaction that includes an insurance request having insurance criteria and an indication of pre-authorization based on the obtained predefined criteria, wherein the generated first transaction is digitally-signed with a unique key associated with the parcel and is generated for communication to a node of a plurality of distributed nodes that collectively maintain a distributed ledger;
determining, by the computing device, that the maintained distributed ledgers include a set of second transactions that each corresponds to one of a set of proposed insurance policies, each transaction in the set of transactions referencing the digitally-signed first transaction; and
communicating, by the computing device, a generated third transaction that corresponds to an optimal insurance policy that is selected from the identified set of proposed insurance policies based on the predefined criteria, wherein the generated third transaction is digitally-signed with the unique key.

17. The computer-implemented method of claim 16, wherein the first sensor is physically coupled to the parcel.

18. The computer-implemented method of claim 16, wherein the state of the parcel is associated with an environmental condition of the parcel at a particular moment in time.

19. The computer-implemented method of claim 16, wherein an electronic communication is sent to a computing device associated with an entity sending or receiving the parcel that the second generated transaction has been communicated to the node.

20. The computer-implemented method of claim 16, wherein the indication of pre-authorization that are each defined by the obtained predefined criteria is associated with a third transaction of the distributed ledger, the third transaction comprising a digital-signature of an entity sending or receiving the parcel.
